(19) United States
(12) Patent Application Publication
(10) Pub. No.: US 2026/0307393 A1
(43) Pub. Date: Oct. 8, 2026

(54) APPARATUS AND METHOD FOR INK REFILL OF A CAN DECORATOR

(71) Applicant: Stolle Machinery Company, LLC, Centennial, CO (US)

(72) Inventors: Ian Kenneth Scholey, Barnsley (GB); Bryon Lee Kajfosz, Littleton, CO (US); Fabricio Scabello Gomes, Araraquara (BR); Stephen Dane Christensen, Highlands Ranch, CO (US)

(73) Assignee: Stolle Machinery Company, LLC, Centennial, CO (US)

(21) Appl. No.: 19/171,828

(22) Filed: Apr. 7, 2025

(51) Int. Cl. B41J 2/175; B25J 18/00; B41J 3/407

(52) U.S. Cl. CPC B41J 2/17523; B25J 18/00; B41J 2/17556; B41J 3/40733

(57) ABSTRACT

An ink refill cartridge of a decorator machine for a can production line has a body with an ink reservoir. The ink reservoir is connected to a nozzle. The ink refill cartridge has an actuator connected to the ink reservoir. The actuator moves the fluid from the ink reservoir out through the nozzle when operated in an output direction.

### FIELD OF THE INVENTION

The disclosed concept relates generally to can decorators. More particularly, the invention relates to an end of arm tooling for refilling ink cartridges on a can decorator.

### BACKGROUND OF THE INVENTION

High speed continuous motion machines for decorating cans, commonly referred to as “can decorator machines” or simply “can decorators,” are generally well known. As shown in FIG. 1, a can decorator 2 includes an infeed conveyor 15, which receives cans 16 from a can supply (not shown) and directs them to arcuate cradles or pockets 17 along the periphery of spaced parallel rings secured to a pocket wheel 12. The pocket wheel 12 is fixedly secured to a continuously rotating mandrel carrier wheel 18, which in turn is keyed to a continuously rotating horizontal drive shaft 19. Horizontal spindles or mandrels (not shown), each being pivotable about its own axis, are mounted to the mandrel carrier wheel 18 adjacent its periphery. Downstream from the infeed conveyor 15, each spindle or mandrel is in closely spaced axial alignment with an individual pocket 17, and undecorated cans 16 are transferred from the pockets 17 to the mandrels. Suction applied through an axial passage of the mandrel draws the can 16 to a final seated position on the mandrel.

While mounted on a mandrel, each can 16 is decorated by being brought into engagement with a blanket (e.g., without limitation, a replaceable adhesive-backed piece of rubber) disposed on a blanket wheel of the multicolor printing unit indicated generally by reference numeral 22. Thereafter, and while still mounted on the mandrels, the outside of each decorated can 16 is coated with a protective film of varnish applied by engagement with the periphery of a varnish applicator roll (not shown) rotating on a shaft 23 in the overvarnish unit indicated generally by reference numeral 24. Cans 16 with decorations and protective coatings thereon are then transferred from the mandrels to suction cups (not shown) mounted adjacent the periphery of a transfer wheel (not shown) rotating on a shaft 28 of a transfer unit 27. From the transfer unit 27 the cans 16 are deposited on generally horizontal pins 29 carried by a chain-type output conveyor 30, which carries the cans 16 through a curing oven (not shown).

While moving toward engagement with an undecorated can 16, the blanket engages a plurality of printing cylinders 31, each of which is associated with an individual ink station assembly 32 (eight ink station assemblies 32 are shown in the exemplary can decorator of FIG. 1). Typically, each assembly 32 provides a different color ink and each printing cylinder 31 applies a different ink image segment to the blanket. All of the “ink image” segments combine to produce a “main image” that is structured to be applied to the can body. The “main image” is then transferred to undecorated cans 16 and becomes, as used herein, the “can body applied image.”

Each ink station assembly 32 includes a plurality of rollers, or as used herein, “rolls,” that are structured to transfer a quantity of ink from a reservoir, or as used herein an “ink fountain,” to the blanket. The path that the ink travels is, as used herein, identified as the “ink train.” That is, the rolls over which the ink travels define the “ink train.” Further, as used herein, the “ink train” has a direction with the ink fountain being at the “upstream” end of the ink train and a printing cylinder 31 at the “downstream” end of the ink train.

The ink train extends over a number of rolls each of which has a purpose. As shown, the ink train starts at the ink fountain and is initially applied as a film to a fountain roll. The fountain roll is intermittently engaged by a ductor roll. When the ductor roll engages the fountain roll, a quantity of ink is transferred to the ductor roll. The ductor roll also intermittently engages a downstream roll and transfers ink thereto. The ductor roll has a “duty cycle” which, as used herein, means the ratio of the duration of the ductor roller being in contact with the fountain roller divided by the duration of a complete cycle (ductor roller in contact with the fountain roller, move to the first downstream roller, contact with first steel roller, move back to fountain roller).

The other rolls include, but are not limited to, distribution roll(s), oscillator roll(s), and transfer roll(s). Generally, these rolls are structured to distribute the ink so that a proper amount of ink is generally evenly applied to the printing cylinder 31. For example, the oscillator rolls are structured to reciprocate longitudinally about their axis of rotation so as to spread the ink as it is applied to the next downstream roll. The final roll is the printing cylinder 31 which applies the ink to the blanket. It is understood that each ink station assembly 32 applies an “ink image” of a single selected color to the blanket and that each ink station assembly 32 must apply an ink image in a proper position relative to the other ink images so that the main image does not have offset ink images.

Various colors of ink are typically loaded manually into corresponding ink fountains. However, when various colors of ink are utilized, the components responsible for transporting ink must be cleaned or discarded if they are going to be used with a second color. However, these ink fountains may be difficult and inconvenient to access. Coming into close proximity to an operating can decorator may also be unsafe for an operator. It is also time consuming for an operator to manually fill the ink fountains. Additionally, after a particular run of cans has been decorated, the can decorator may need to be reconfigured for a run of cans that uses a different image. For example, the colors and amounts of ink used by each ink station may change for the new run of cans.

Previously, pumping systems have been utilized to move ink through tubes between the ink pails and the ink fountains of the ink station assemblies. However, when a label change is needed and new color inks must be used, the contaminated ink transfer tubes still needed to be manually removed by the operator and either washed or discarded.

The waste, time, and safety issues associated with manually removing, refilling, and/or disposing of transfer tubes for ink fountains are a problem. There is, therefore, room for improvement in can decorating machines and systems for replenishing ink in can decorator machines.

### SUMMARY OF THE INVENTION

These needs, and others, are met by the presently disclosed technology, which provides a means of transferring ink from its original packaging, such as an ink pail, into the ink fountains of a can decorator.

In one exemplary embodiment of the presently disclosed technology, an ink refill cartridge of a decorator machine for a can product line may include a body having an ink reservoir with a nozzle disposed on an end thereof. The nozzle is in fluid communication with the ink reservoir. The ink refill cartridge may further include an actuator disposed in the ink reservoir. The actuator is movable between an input direction and an output direction. The actuator is configured to move a fluid into the ink reservoir through the nozzle when operated in an input direction. The actuator is also configured to move the fluid from the ink reservoir out through the nozzle when operated in an output direction. A coupling assembly is configured to attach the ink refill cartridge to a robotic arm.

In another exemplary embodiment of the presently disclosed technology, an apparatus for refilling a plurality of ink fountains on a can decorator may include a plurality of ink pails and a plurality of ink refill cartridges. Each ink refill cartridge may include a body having an ink reservoir with a nozzle disposed on an end thereof. The nozzle is in fluid communication with the ink reservoir. The ink refill cartridge further may include an actuator disposed in the ink reservoir. The actuator is movable between an input direction and an output direction. The actuator is configured to move a fluid into the ink reservoir through the nozzle when operated in an input direction. The actuator is also configured to move the fluid from the ink reservoir out through the nozzle when operated in an output direction. Each ink refill cartridge corresponds to an ink pail. Each ink refill cartridge is configured to attach the ink refill cartridge to a robotic arm. The apparatus for refilling a plurality of ink fountains may further include a robotic arm. The robotic arm may include a proximal end connected to a base and distal end configured to couple to the coupling assembly of each ink refill cartridge.

In a further exemplary embodiment of the presently disclosed technology, a method for transferring ink to an ink fountain of a can product line may include providing at least one ink pail. The ink refill cartridge corresponds to an ink fountain. The distal end of the robotic arm couples to the ink refill cartridge. The nozzle of the ink refill cartridge in placed into the ink fountain. The actuator of the ink refill cartridge is actuated in an output direction to release the fluid into the ink fountain.

### BRIEF DESCRIPTION OF THE DRAWINGS

A full understanding of the invention can be gained from the following description of the preferred embodiments when read in conjunction with the accompanying drawings in which:

FIG. 1 is a schematic cross-sectional view of a can decorator according to the prior art;

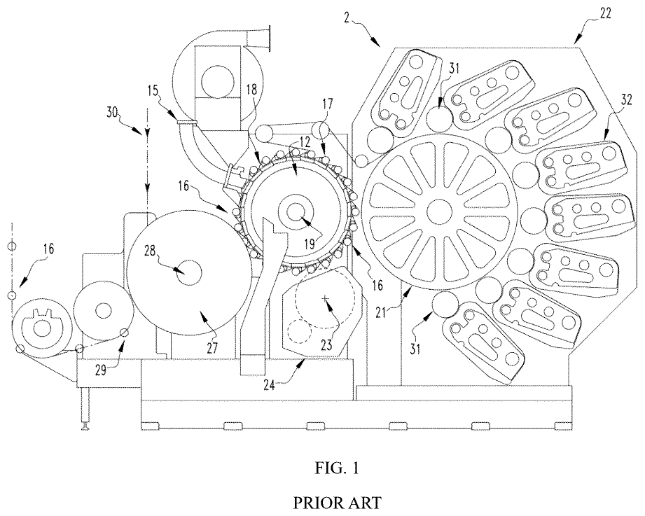

FIG. 2 is a perspective view of a can decorator with an apparatus for refilling a plurality of ink fountains of the presently disclosed technology;

FIG. 3A is a perspective view of an ink station assembly of the presently disclosed technology;

FIG. 3B is a cross-sectional view of an ink station assembly of FIG. 3A along line A-A in FIG. 3A.

FIG. 4 is a perspective view of a robotic arm of the presently disclosed technology;

FIG. 5 is an exploded view of an ink refill cartridge for a can decorator of the presently disclosed technology;

FIG. 6 is a perspective view of a can decorator with an apparatus for refilling a plurality of ink fountains according to one embodiment of the presently disclosed technology;

FIG. 7 is a side view of a can decorator with an apparatus for refilling a plurality of ink fountains according to one embodiment of the presently disclosed technology;

FIG. 8A is a cross-sectional side view of a can decorator with an apparatus for refilling a plurality of ink fountains wherein the ink refill cartridge is inserted into the ink pail according to one embodiment of the presently disclosed technology;

FIG. 8B is a detail view of area 8B of FIG. 8A of an ink refill cartridge inserted into an ink pail according to one embodiment of the presently disclosed technology;

FIG. 9A is a cross-sectional side view of a can decorator with an apparatus for refilling a plurality of ink fountains wherein the ink refill cartridge is pulling ink from an ink pail according to one embodiment of the presently disclosed technology;

FIG. 9B is a detail view of area 9B of FIG. 9A of an ink refill cartridge pulling ink from an ink pail according to one embodiment of the presently disclosed technology;

FIG. 10A is a cross-sectional side view of a can decorator with an apparatus for refilling a plurality of ink fountains wherein the ink refill cartridge is releasing ink into an ink fountain according to one embodiment of the presently disclosed technology;

FIG. 10B is a detail view of area 10B of FIG. 10A of an ink refill cartridge releasing ink into an ink fountain according to one embodiment of the presently disclosed technology;

FIG. 11A is a cross-sectional side view of a can decorator with an apparatus for refilling a plurality of ink fountains wherein the ink refill cartridge has released ink into an ink fountain according to one embodiment of the presently disclosed technology;

FIG. 11B is a detail view of area 11B of FIG. 11A of an ink refill cartridge after releasing ink into an ink fountain according to one embodiment of the presently disclosed technology;

FIG. 12 is a perspective view of a can decorator with an apparatus for refilling a plurality of ink fountains according to one embodiment of the presently disclosed technology;

FIG. 13 is an exploded view of an ink refill cartridge for a can decorator of the presently disclosed technology;

FIG. 14 is a side view of a can decorator with an apparatus for refilling a plurality of ink fountains according to one embodiment of the presently disclosed technology;

FIG. 15A is a cross-sectional side view of a can decorator with an apparatus for refilling a plurality of ink fountains wherein the ink refill cartridge is inserted into the ink pail according to one embodiment of the presently disclosed technology;

FIG. 15B is a detail view of area 15B of FIG. 15A of an ink refill cartridge inserted into an ink pail according to one embodiment of the presently disclosed technology;

FIG. 16A is a cross-sectional side view of a can decorator with an apparatus for refilling a plurality of ink fountains wherein the ink refill cartridge is pulling ink from an ink pail according to one embodiment of the presently disclosed technology;

FIG. 16B is a detail view of area 16B of FIG. 16A of an ink refill cartridge pulling ink from an ink pail according to one embodiment of the presently disclosed technology;

FIG. 17A is a cross-sectional side view of a can decorator with an apparatus for refilling a plurality of ink fountains wherein the ink refill cartridge is releasing ink into an ink fountain according to one embodiment of the presently disclosed technology;

FIG. 17B is a detail view of area 17B of FIG. 17A of an ink refill cartridge releasing ink into an ink fountain according to one embodiment of the presently disclosed technology;

FIG. 17C is an overhead view of an ink refill cartridge releasing ink into an ink fountain according to one embodiment of the presently disclosed technology;

FIG. 18A is a cross-sectional side view of a can decorator with an apparatus for refilling a plurality of ink fountains wherein the ink refill cartridge has released ink into an ink fountain according to one embodiment of the presently disclosed technology;

FIG. 18B is a detail view of area 18B of FIG. 18A of an ink refill cartridge after releasing ink into an ink fountain according to one embodiment of the presently disclosed technology;

FIG. 19 is a perspective view of a can decorator with an apparatus for refilling a plurality of ink fountains according to one embodiment of the presently disclosed technology;

FIG. 20 is an exploded view of an ink refill cartridge for a can decorator of the presently disclosed technology;

FIG. 21 is a side view of a can decorator with an apparatus for refilling a plurality of ink fountains according to one embodiment of the presently disclosed technology;

FIG. 22A is a cross-sectional side view of a can decorator with an apparatus for refilling a plurality of ink fountains wherein the ink refill cartridge is inserted into the ink pail according to one embodiment of the presently disclosed technology;

FIG. 22B is a detail view of area 22B of FIG. 22A of an ink refill cartridge inserted into an ink pail according to one embodiment of the presently disclosed technology;

FIG. 23A is a cross-sectional side view of a can decorator with an apparatus for refilling a plurality of ink fountains wherein the ink refill cartridge is pulling ink from an ink pail according to one embodiment of the presently disclosed technology;

FIG. 23B is a detail view of area 23B of FIG. 23A of an ink refill cartridge pulling ink from an ink pail according to one embodiment of the presently disclosed technology;

FIG. 24A is a cross-sectional side view of a can decorator with an apparatus for refilling a plurality of ink fountains wherein the ink refill cartridge is releasing ink into an ink fountain according to one embodiment of the presently disclosed technology;

FIG. 24B is a detail view of area 24B of FIG. 24A of an ink refill cartridge releasing ink into an ink fountain according to one embodiment of the presently disclosed technology;

FIG. 24C is an overhead view of an ink refill cartridge releasing ink into an ink fountain according to one embodiment of the presently disclosed technology;

FIG. 25A is a cross-sectional side view of a can decorator with an apparatus for refilling a plurality of ink fountains wherein the ink refill cartridge has released ink into an ink fountain according to one embodiment of the presently disclosed technology;

FIG. 25B is a detail view of area 25B of FIG. 25A of an ink refill cartridge after releasing ink into an ink fountain according to one embodiment of the presently disclosed technology;

FIG. 26 is a perspective view of a can decorator with an apparatus for refilling a plurality of ink fountains according to one embodiment of the presently disclosed technology;

FIG. 27 is a perspective view of a can decorator with an apparatus for refilling a plurality of ink fountains according to one embodiment of the presently disclosed technology;

FIG. 28 is an exploded view of an ink refill cartridge for a can decorator of the presently disclosed technology;

FIG. 29 is a side elevation view of a can decorator with an apparatus for refilling a plurality of ink fountains according to one embodiment of the presently disclosed technology;

FIG. 30A is a cross-sectional side view of a can decorator with an apparatus for refilling a plurality of ink fountains wherein the ink refill cartridge is selected by the robotic arm;

FIG. 30B is a detail view of area 30B of FIG. 30A of an ink refill cartridge inserted into an ink pail according to one embodiment of the presently disclosed technology;

FIG. 31A is a cross-sectional side view of a can decorator with an apparatus for refilling a plurality of ink fountains wherein the ink refill cartridge is releasing ink into an ink fountain according to one embodiment of the presently disclosed technology;

FIG. 31B is a detail view of area 31B of FIG. 31A of an ink refill cartridge releasing ink into an ink fountain according to one embodiment of the presently disclosed technology;

FIG. 31C is an overhead view of an ink refill cartridge releasing ink into an ink fountain according to one embodiment of the presently disclosed technology;

FIG. 32A is a cross-sectional side view of a can decorator with an apparatus for refilling a plurality of ink fountains wherein the ink refill cartridge has released ink into an ink fountain according to one embodiment of the presently disclosed technology;

FIG. 32B is a detail view of area 32B of FIG. 32A of an ink refill cartridge after releasing ink into an ink fountain according to one embodiment of the presently disclosed technology; and

FIG. 33 is a perspective view of a can decorator with an apparatus for refilling a plurality of ink fountains according to one embodiment of the presently disclosed technology.

### DETAILED DESCRIPTION OF THE INVENTION

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move, or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb, but which is not intended to, and is not designed to, perform the identified verb is not “structured to [verb].”

As used herein, “associated” means that the elements are part of the same assembly and/or operate together, or act upon/with each other in some manner. For example, an automobile has four tires and four hub caps. While all the elements are coupled as part of the automobile, it is understood that each hubcap is “associated” with a specific tire.

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut.

As used herein, a “fastener” is a separate component structured to couple two or more elements. Thus, for example, a bolt is a “fastener”, but a tongue-and-groove coupling is not a “fastener.” That is, the tongue-and-groove elements are part of the elements being coupled and are not a separate component.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled” or “temporarily coupled” means that one component is coupled with another component in an essentially temporary manner. That is, the two components are coupled in such a way that the joining or separation of the components is easy and would not damage the components. For example, two components secured to each other with a limited number of readily accessible fasteners, i.e., fasteners that are not difficult to access, are “removably coupled” whereas two components that are welded together or joined by difficult to access fasteners are not “removably coupled.” A “difficult to access fastener” is one that requires the removal of one or more other components prior to accessing the fastener wherein the “other component” is not an access device such as, but not limited to, a door.

As used herein, “temporarily disposed” means that a first element(s) or assembly(ies) is resting on a second element(s) or assembly(ies) in a manner that allows the first element/assembly to be moved without having to decouple or otherwise manipulate the first element. For example, a book simply resting on a table, i.e., the book is not glued or fastened to the table, is “temporarily disposed” on the table.

As used herein, “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true.

As used herein, a “path of travel” or “path,” when used in association with an element that moves, includes the space an element moves through when in motion. As such, any element that moves inherently has a “path of travel” or “path.” Further, a “path of travel” or “path” relates to a motion of one identifiable construct as a whole relative to another object. For example, assuming a perfectly smooth road, a rotating wheel (an identifiable construct) on an automobile generally does not move relative to the body (another object) of the automobile. That is, the wheel, as a whole, does not change its position relative to, for example, the adjacent fender. Thus, a rotating wheel does not have a “path of travel” or “path” relative to the body of the automobile. Conversely, the air inlet valve on that wheel (an identifiable construct) does have a “path of travel” or “path” relative to the body of the automobile. That is, while the wheel rotates and is in motion, the air inlet valve, as a whole, moves relative to the body of the automobile.

As used herein, the statement that two or more parts or components “engage” one another means that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “temporarily coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate. Further, with electronic components, “operatively engage” means that one component controls another component by a control signal or current.

As used herein, the term “number” shall mean one or an integer greater than one (i.e., a plurality). That is, for example, the phrase “a number of elements” means one element or a plurality of elements.

As used herein, in the phrase “[x] moves between its first position and second position,” or, “[y] is structured to move [x] between its first position and second position,” “[x]” is the name of an element or assembly. Further, when [x] is an element or assembly that moves between a number of positions, the pronoun “its” means “[x],” i.e., the named element or assembly that precedes the pronoun “its.”

As used herein, “about” in a phrase such as “disposed about [an element, point or axis]” or “extend about [an element, point or axis]” or “[X] degrees about an [an element, point or axis],” means encircle, extend around, or measured around. When used in reference to a measurement or in a similar manner, “about” means “approximately,” i.e., in an approximate range relevant to the measurement as would be understood by one of ordinary skill in the art.

As used herein, a “radial side/surface” for a circular or cylindrical body is a side/surface that extends about, or encircles, the center thereof or a height line passing through the center thereof. As used herein, an “axial side/surface” for a circular or cylindrical body is a side that extends in a plane extending generally perpendicular to a height line passing through the center. That is, generally, for a cylindrical soup can, the “radial side/surface” is the generally circular sidewall, and the “axial side(s)/surface(s)” are the top and bottom of the soup can.

As used herein, a “customer side” means the side of a construct used in a container that does not contact, or could not contact, a product such as, but not limited to, a food or beverage. That is, the “customer side” of the construct is the side of the construct that, eventually, defines the exterior of a container.

As used herein, “generally” means “in a general manner” relevant to the term being modified as would be understood by one of ordinary skill in the art.

As used herein, “substantially” means “for the most part” relevant to the term being modified as would be understood by one of ordinary skill in the art.

As used herein, “at” means on and/or near relevant to the term being modified as would be understood by one of ordinary skill in the art.

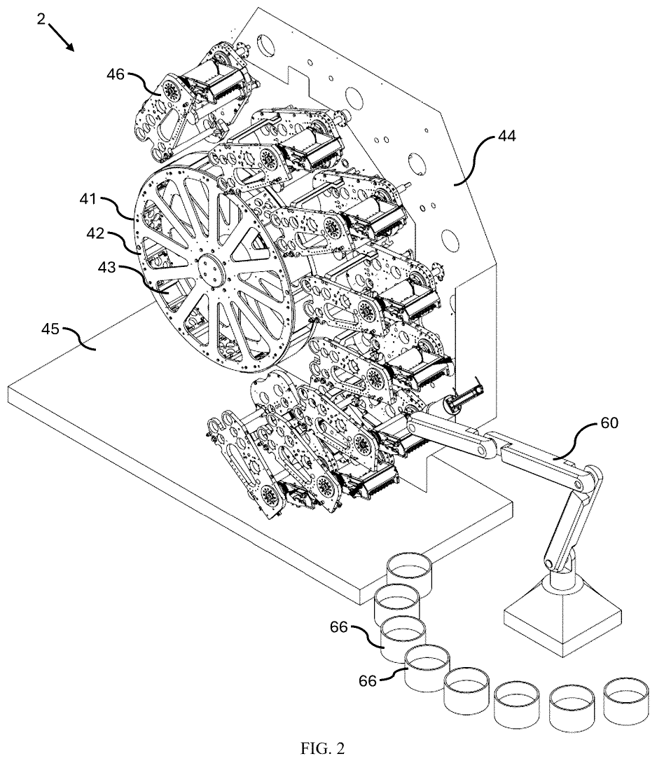

As shown in FIG. 2, a can decorator 2 generally includes a blanket wheel 41. The blanket wheel 41 may include a wheel frame 42 with a plurality of image transfer segments 43 disposed around a perimeter thereof. In the specific optional embodiment shown, the blanket wheel 41 is mounted upon a can decorator support frame 44 extending from a can decorator base 45. A plurality of ink station assemblies 46 is concentrically disposed around the blanket wheel 41.

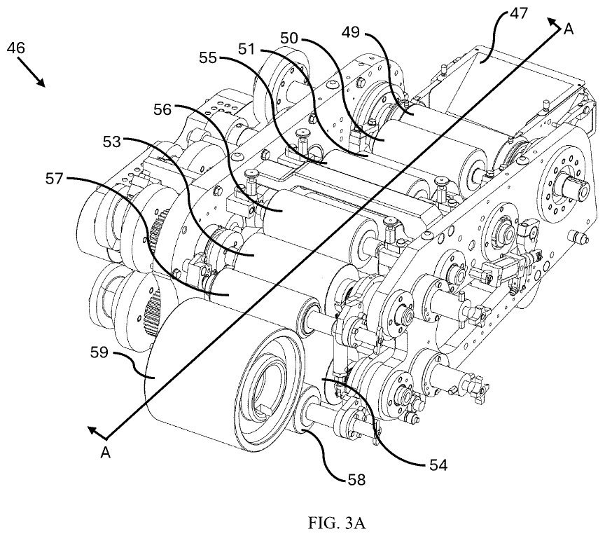

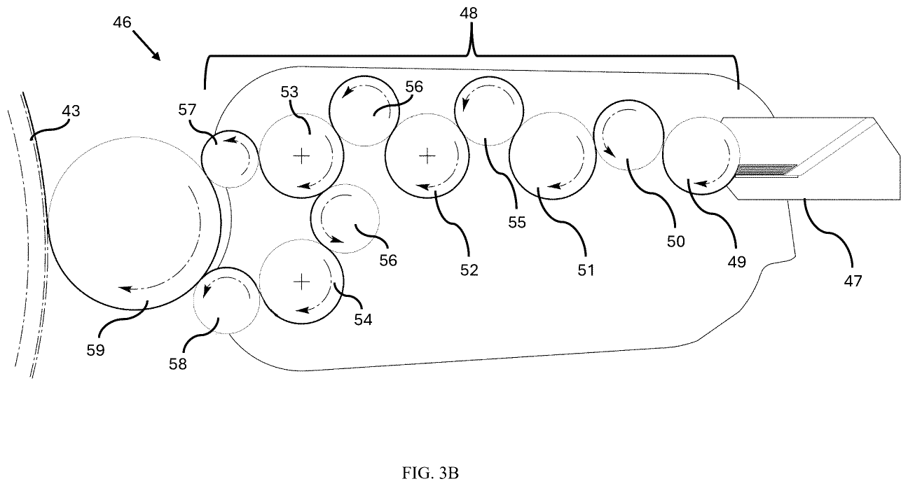

As shown in FIGS. 3A and 3B, each ink station assembly 46 may include an ink fountain 47 in operable connection with an ink roller assembly 48. The ink roller assembly 48 may include a plurality of rollers each fulfilling a specific function. For example, in the illustrated embodiment, the ink roller assembly may include a fountain roll 49, a ductor roll 50, a distributor roll 51, a plurality of oscillating rolls, 52, 53, 54, a pair of transfer rolls 55, 56, and a pair of form rolls 57, 58. Ultimately, the ink roller assembly 48 is configured to move and refine ink from the ink fountain 47 to the printing plate 59. In turn, the printing plate 59 will transfer the ink onto one or more cans, thus decorating the can with ink.

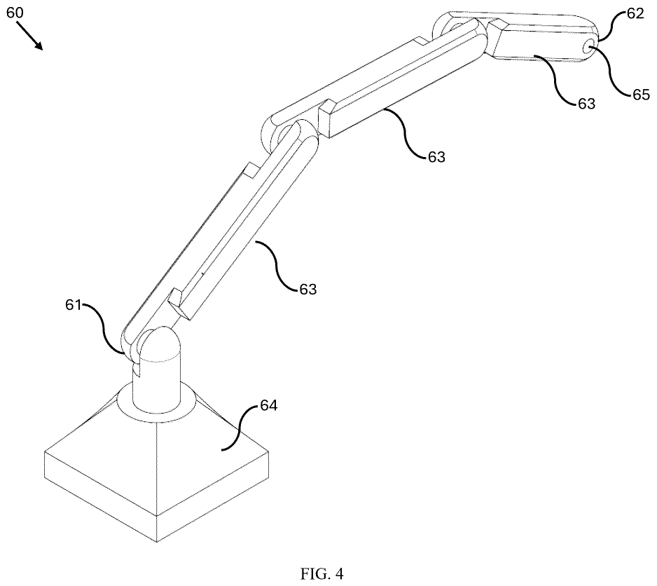

In an optional embodiment, a robotic arm 60 is utilized to move one or more ink refill cartridges 100 into and away from the plurality of ink station assemblies 46. In the illustrated embodiment shown in FIG. 4, the robotic arm 60 may include a proximal end 61 disposed opposite a distal end 62 with a plurality of rotatably affixed segments defined therebetween 63. The proximal end 61 of the robotic arm 60 is affixed to a base 64. A coupling 65 is disposed on a distal end 62 of the uppermost segment. The coupling 65 forms a coupling assembly when engaged with a corresponding coupling. For example, an ink refill cartridge 200 may include a corresponding coupling 205, such that the robotic arm 60 may selectively pick up and put down a specific ink refill cartridge 100.

An ink refill cartridge 200 may include a body with an ink reservoir 202 and a nozzle 203. The nozzle 203 is in fluid communication with the ink reservoir 202. The ink container may be the original packaging in which the ink is sold, such as to reduce the need to transfer delivered ink into a vat or pail 66. In such an embodiment, the body is structured to form a seal around an opening of the ink container such that ink will not leak out of the ink container when connected to the ink refill cartridge 200. In one embodiment, the

An actuator 204 is in operable connection with the ink reservoir 202. The actuator 204 is movable in an input direction and in an output direction. When moved in the input direction, the actuator 204 will move a fluid, such as ink, into the ink reservoir 202. When moved in the output direction, the actuator 204 will move a fluid, such as ink, out through the nozzle 203 into a targeted area, such as an ink fountain of a can decorator machine. In the exemplary embodiment, the actuator 204 is in operable connection with a motor 219. The motor 219 is configured to supply power to the actuator 204 such that the actuator 204 can be moved in the input direction and the output direction.

The ink refill cartridge 200 may include a coupling assembly 205. The coupling assembly 205 is configured to attach the ink refill cartridge to a robotic arm 60. In the demonstrated embodiments, the coupling assembly 205 may include a cylindrical protrusion configured to be received by an aperture of the robotic arm 60. However, it is to be understood that any alternatively configured coupling assembly 205 structured to removably couple the ink refill cartridge 100 to the robotic arm 60 may be utilized.

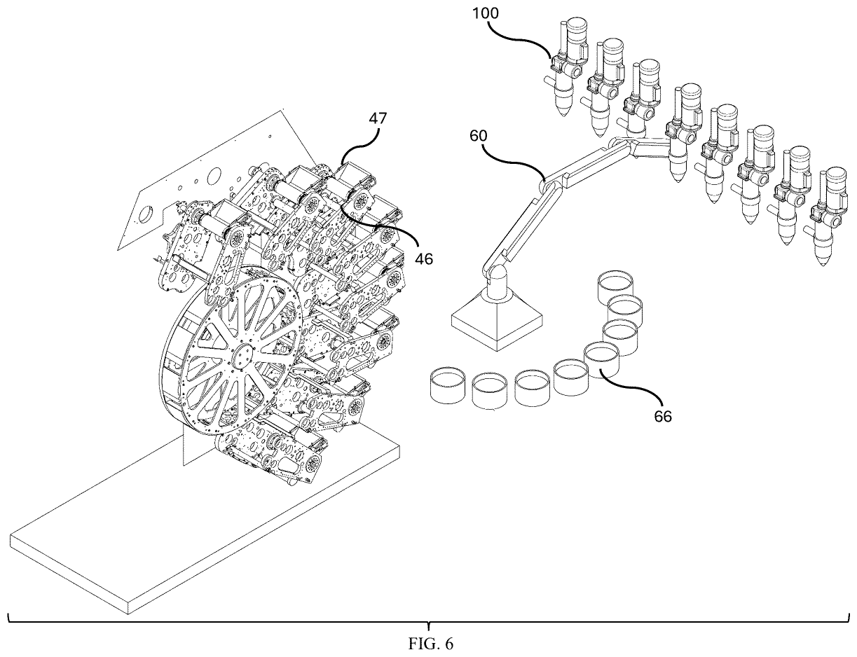

In a can decorator, each ink station assembly of the plurality of ink station assemblies 46 is configured to print a specific color on the printing plate 59 and in turn on the can. In the optional embodiment shown in FIG. 6, a plurality of ink refill cartridges 100 are placed in the vicinity of the can decorator 2 and the robotic arm 60. As such, the robotic arm 60 may selectively couple to an ink refill cartridge of the plurality of ink refill cartridges 100. Furthermore, in the optional embodiment of FIG. 6, a plurality of ink pails 66 is provided in the range of the robotic arm 60. As shown, each ink refill cartridge of the plurality of ink refill cartridges 100 corresponds to an ink pail of the plurality of ink pails 66. As such, no color contamination will occur because no single ink refill cartridge will be used with multiple colors of ink. Furthermore, each ink refill cartridge of the plurality of ink refill cartridges 100 corresponds to an ink station assembly of the plurality of ink station assemblies 46 disposed on around the blanket wheel 41. As such, no color contamination will occur as no single ink refill cartridge will be used to refill different ink colors.

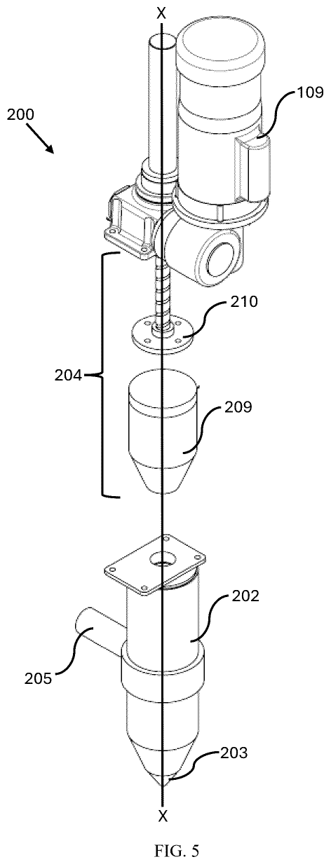

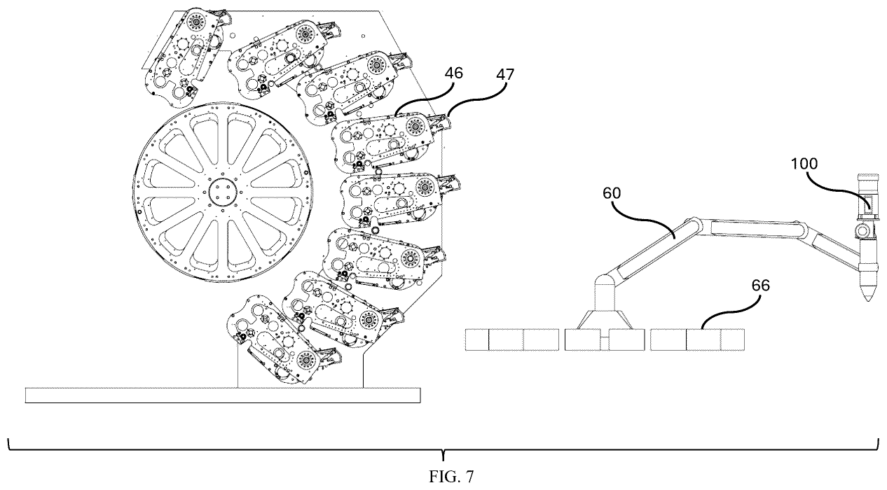

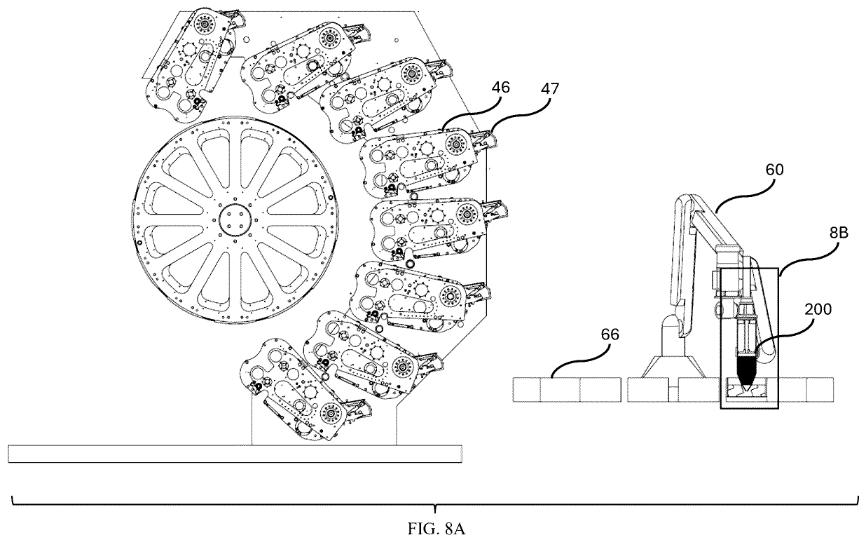

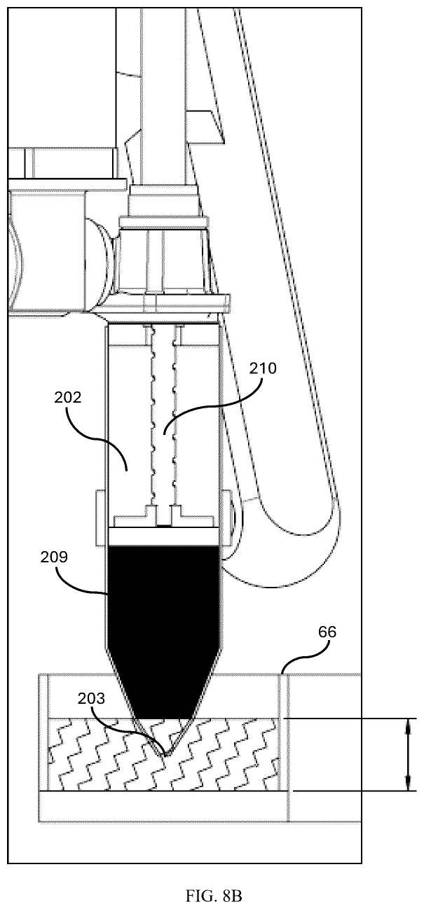

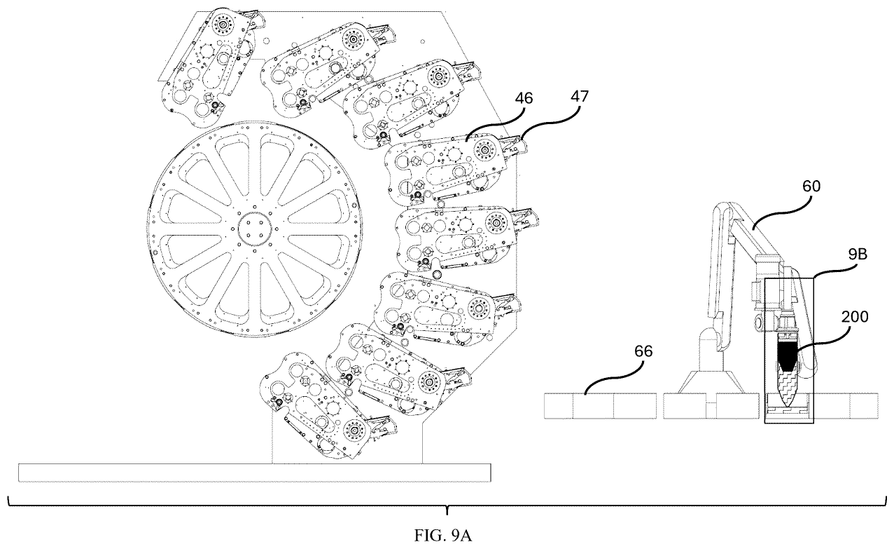

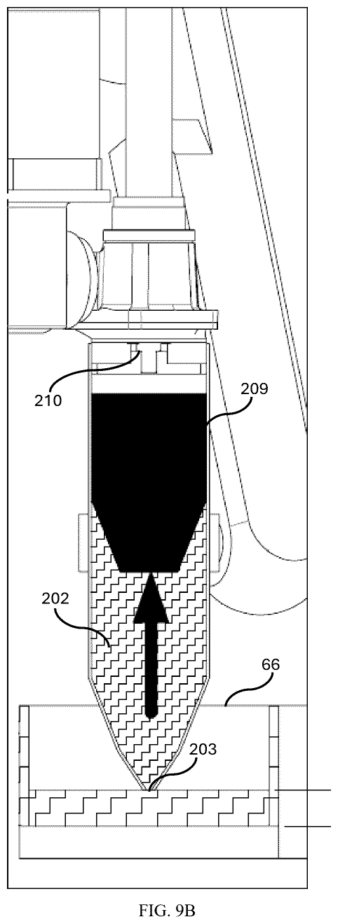

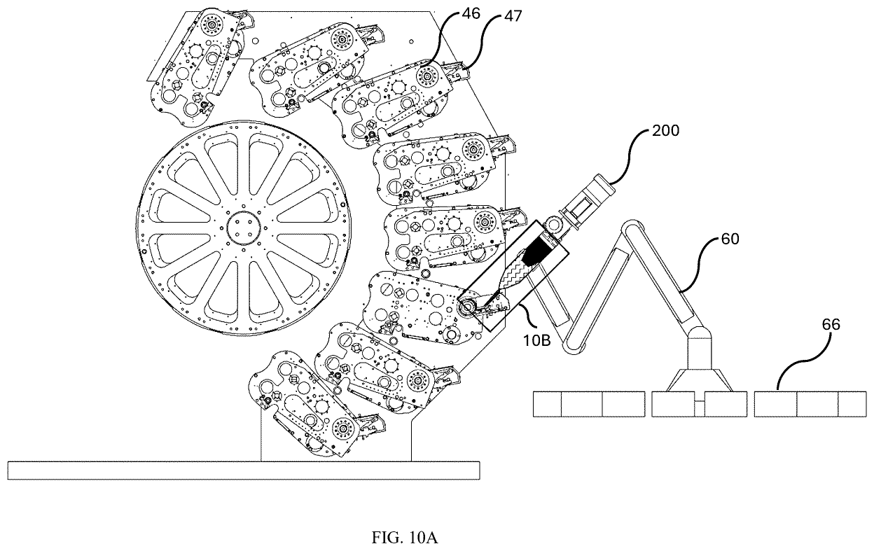

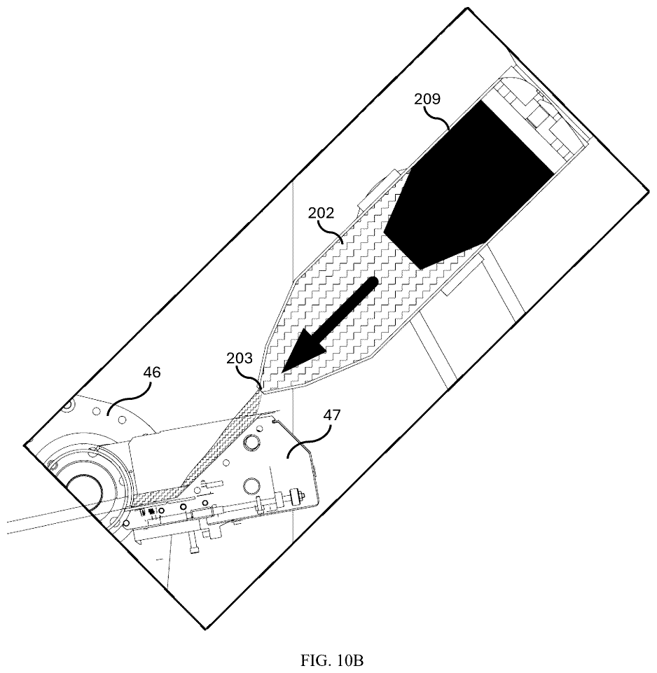

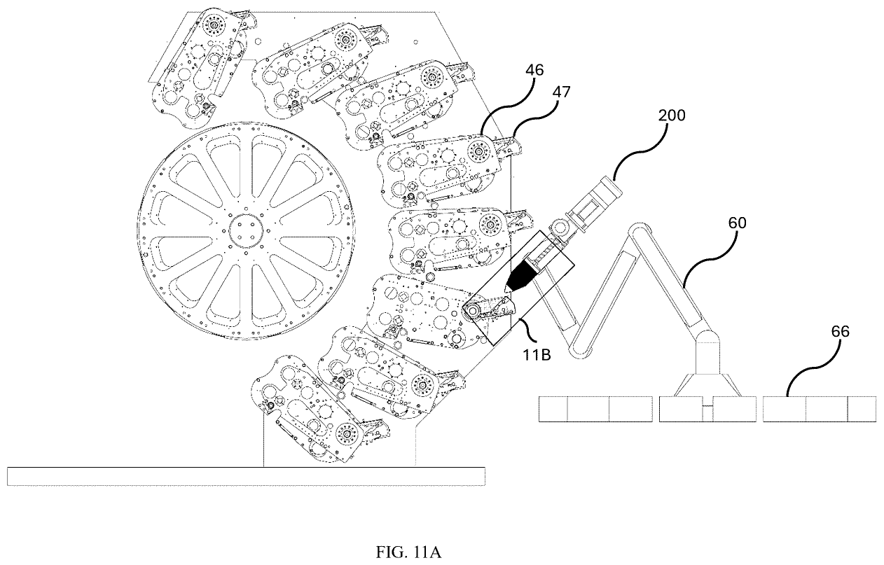

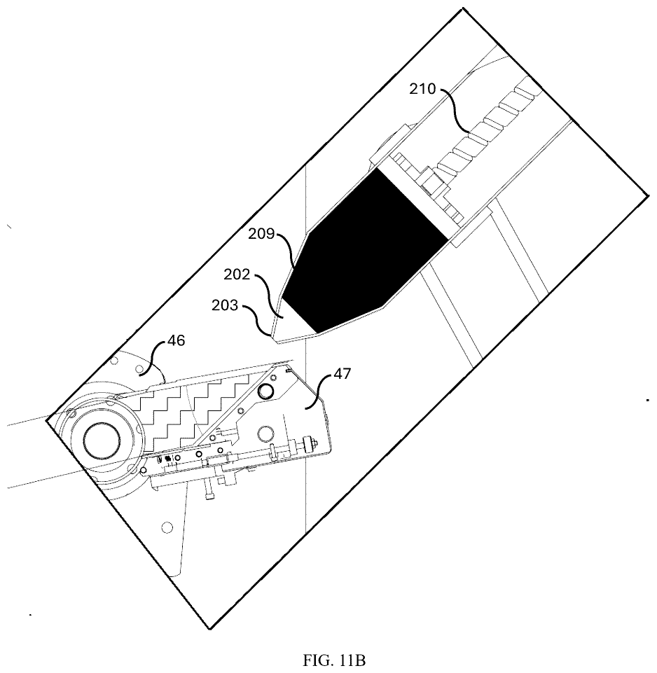

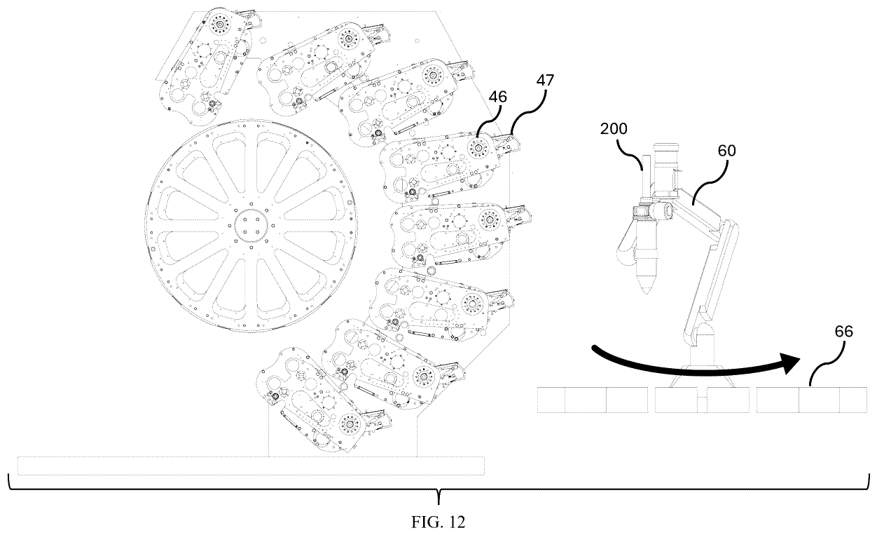

In the optional embodiment shown in FIGS. 5-12, the actuator 204 is a plunger 209 operably connected to a screw jack 210. In FIGS. 8A and 8B, the plunger 209 is shown in an extended position, putting the plunger 209 in a position adjacent to the nozzle 203. The input direction is defined where the screw jack 210 is rotated along a vertical axis (shown as line X-X in FIG. 5) in a first rotational direction, moving the plunger 209 away from the nozzle 203. As shown in FIGS. 9A and 9B, this creates a vacuum that pulls the fluid, such as ink, into the ink reservoir 202 through the nozzle 203. In an optional embodiment, the actuator 204 is calibrated such that moving the actuator in the input direction entirely fills the ink reservoir 202 with a fluid, such as ink. Alternatively, the actuator 204 may be programmed to fill the ink reservoir 202 with a desired amount of the fluid, such as ink. As demonstrated in FIGS. 10A and 10B, the output direction is defined where the screw jack 210 is rotated along the vertical axis in a second rotational direction, moving the plunger 209 toward the nozzle 203. As shown in FIGS. 11A and 11B, the ink reservoir 402 may be depleted through the movement of the plunger 209 and the screw jack 210 in the output direction. In an optional embodiment, the plunger 209 is shaped to fully evacuate the fluid, such as ink, from the ink reservoir 202.

In use, the ink refill cartridge 200 of the optional embodiment of FIGS. 5-12 is coupled to the robotic arm 60. The robotic arm 60 is configured to place the ink refill cartridge 200 into a corresponding ink pail 66. Once the nozzle 203 is at least partially submerged in the ink stored in the ink pail 66, the actuator 204 is moved in the input direction. When moved in the input direction, the screw jack 210 is rotated in the first rotational direction around the vertical axis, pulling the plunger 209 upward, creating a vacuum that pulls the ink in the ink pail 66 through the nozzle 203 and into the ink reservoir 202. Once the ink reservoir 202 is sufficiently filled with ink, the robotic arm 60 moves the ink refill cartridge 200 to an ink fountain 47 of a corresponding ink station assembly 46. When the nozzle 203 is aligned with the ink fountain 47, the actuator 204 is moved in the output direction. When the actuator 204 is moved in the output direction, the screw jack 210 is rotated in a second rotational direction around the vertical axis. The second rotational direction is opposite the first rotational direction around the vertical axis. For example, when the first rotational direction is a clockwise direction around the vertical axis, the second rotational direction is a counterclockwise direction around the vertical axis. Rotating the screw jack 210 in the second rotational direction pushes the plunger 209 toward the nozzle 203, thus pushing the ink in the ink reservoir 202 outward from the nozzle 203 into the ink fountain 47. Once a sufficient volume of ink is pushed into the ink fountain 47, the robotic arm 60 returns the ink refill cartridge 200 to a desired location and uncouples from the ink refill cartridge 200. As such, the robotic arm 60 may couple with another ink refill cartridge corresponding to a different ink station assembly 46 in need of refill.

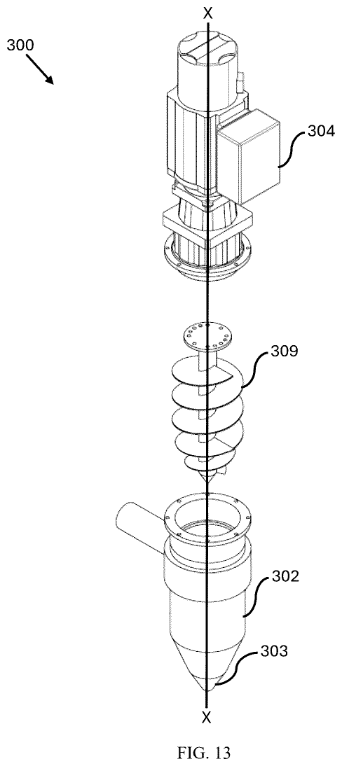

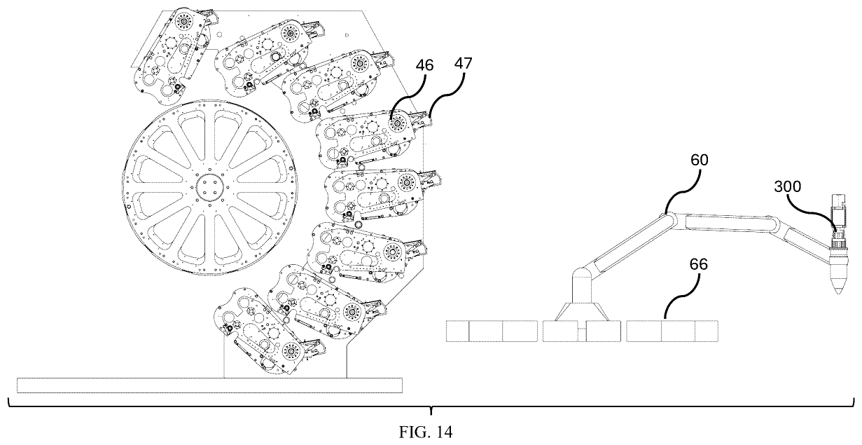

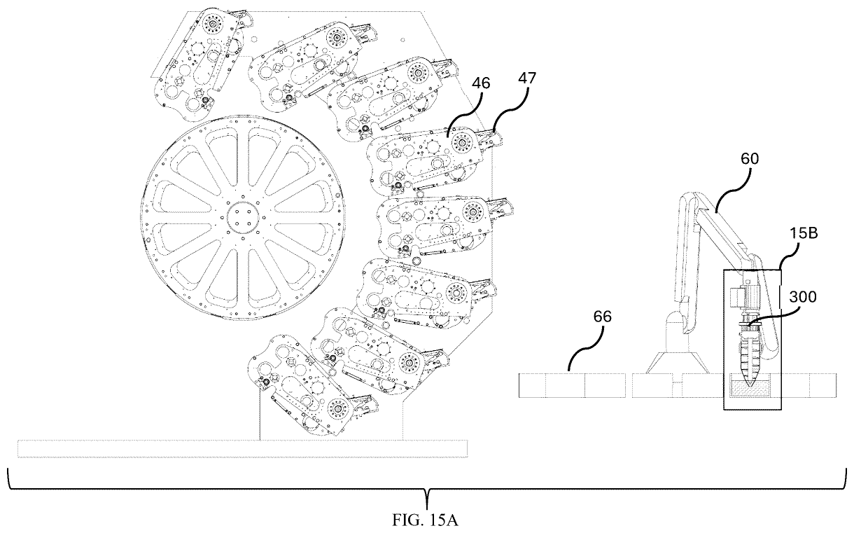

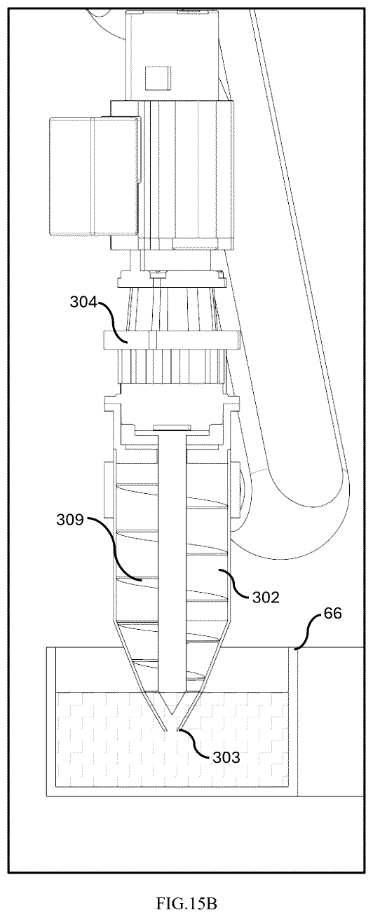

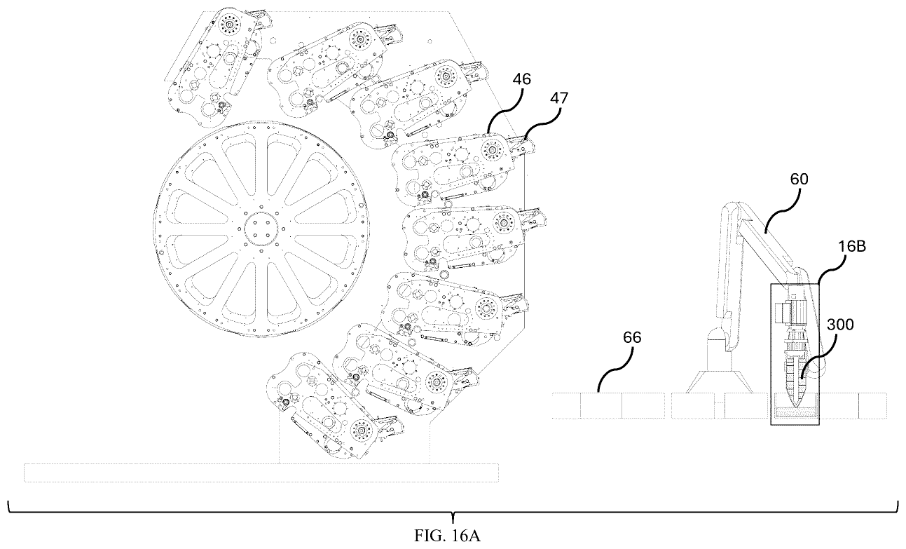

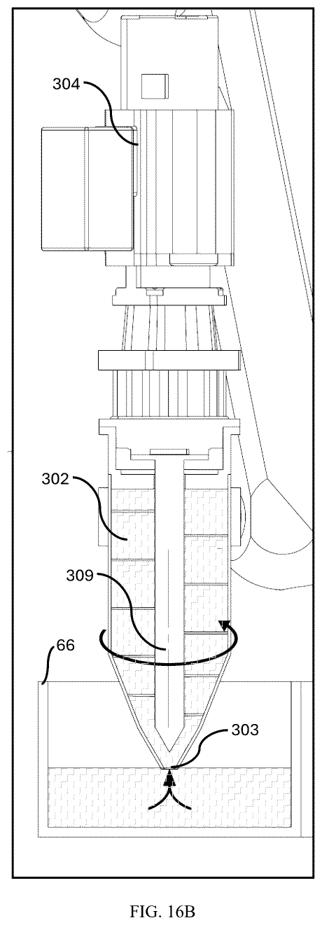

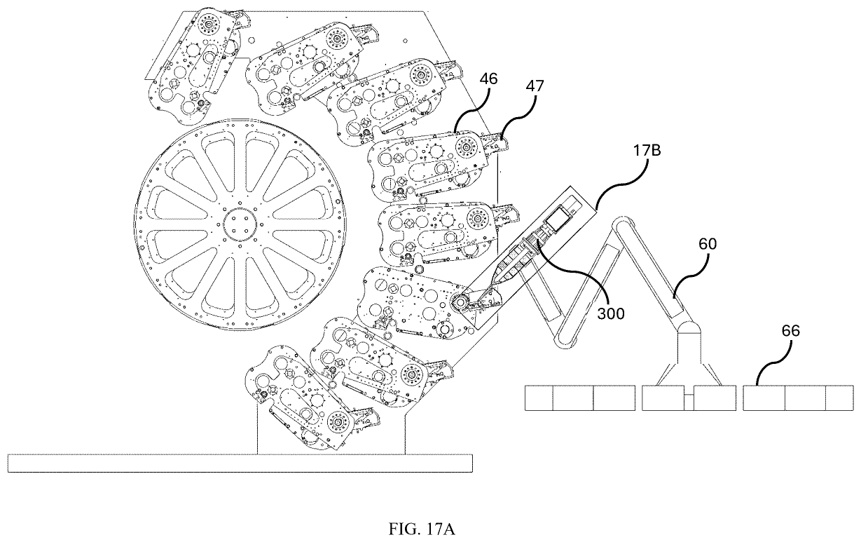

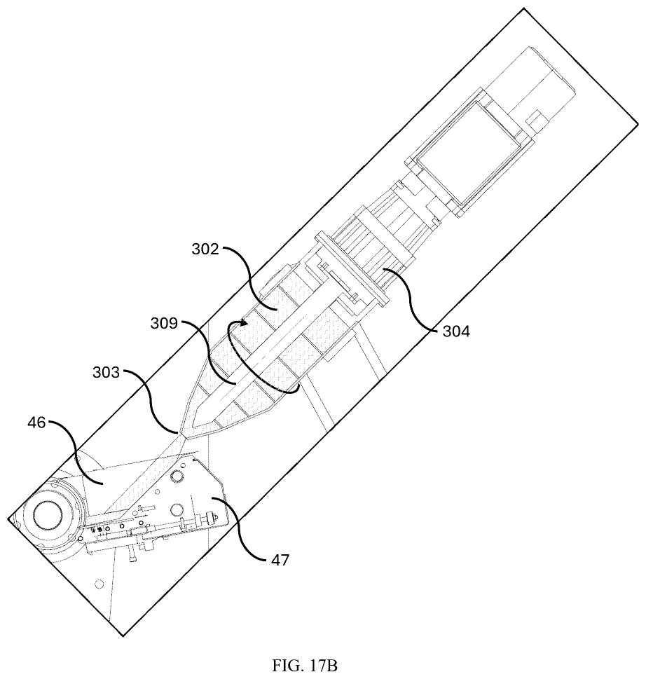

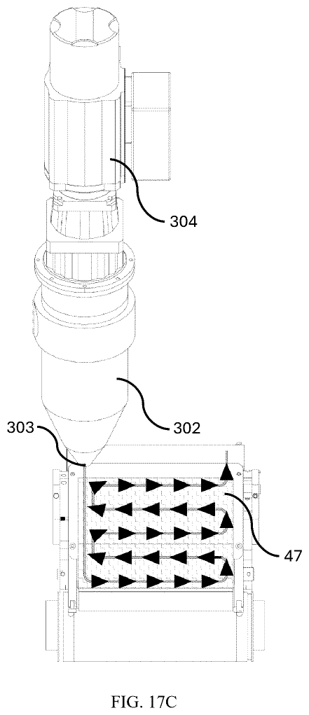

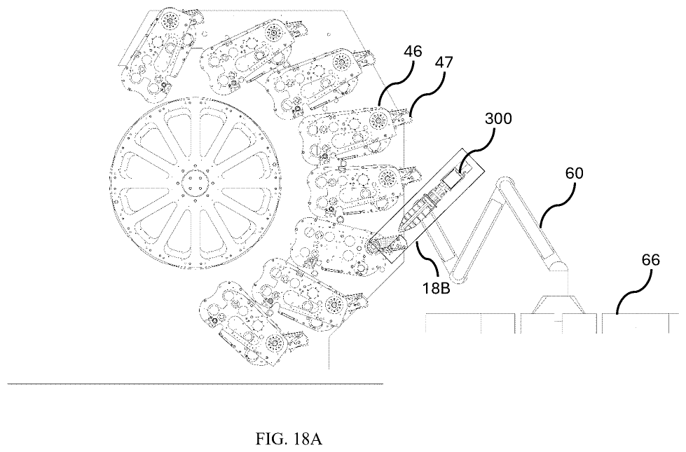

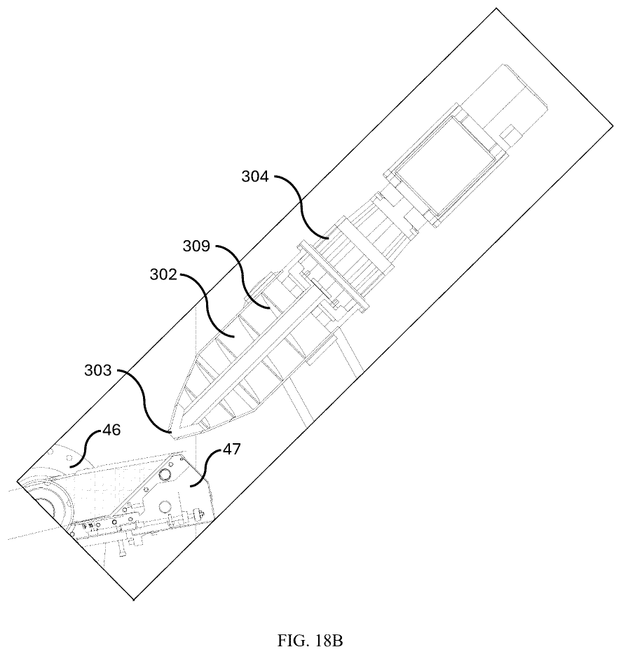

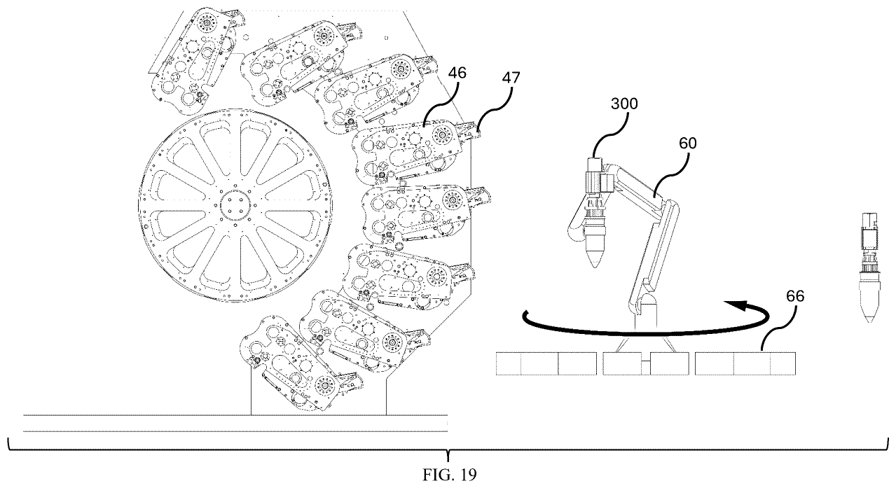

In the optional embodiment shown in FIGS. 13-19, the actuator 304 is a mechanical auger 309 in operable connection with a motor 319. In FIGS. 15A and 15B, the auger 309 is shown in an extended position, wherein a distal end 309 of the mechanical auger 309 is disposed adjacent to the nozzle 303. The input direction is defined where the mechanical auger 309 is rotated along a vertical axis (shown as line X-X in FIG. 13) in a first rotational direction. As shown in FIGS. 16A and 16B, this generates a pulling force to pull the fluid, such as ink, into the ink reservoir 302 through the nozzle 303. In an optional embodiment, the mechanical auger 309 is calibrated such that rotating the mechanical auger 309 in the first rotational direction entirely fills the ink reservoir 202 with a fluid, such as ink, when moved in the input direction. Alternatively, the mechanical auger 309 may be programmed to fill the ink reservoir 302 with a desired amount of the fluid, such as ink. As shown in FIGS. 17A, 17B, and 17C, the output direction is defined where the mechanical auger 309 is rotated along the vertical axis in a second rotational direction. This generates a pushing force that pushes fluid from the ink reservoir 302 through the nozzle 303 and out of the ink refill cartridge 300.

In use, the ink refill cartridge 300 of the optional embodiment of FIGS. 13-19 is coupled to the robotic arm 60. The robotic arm 60 is configured to place the ink refill cartridge 300 into a corresponding ink pail 66. Once the nozzle 303 is at least partially submerged in the ink stored in the ink pail 66, the mechanical auger 309 is moved in the input direction. When moved in the input direction, the mechanical auger is rotated in the first rotational direction around the vertical axis, creating a vacuum that pulls the ink in the ink pail 66 through the nozzle 303 and into the ink reservoir 302. Once the ink reservoir 302 is sufficiently filled with ink, the robotic arm 60 moves the ink refill cartridge 300 to an ink fountain 47 of a corresponding ink station assembly 46. When the nozzle 303 is aligned with the ink fountain 47, the mechanical auger 309 is moved in the output direction. When the mechanical auger 309 is moved in the output direction, the mechanical auger 309 is rotated in a second rotational direction around the vertical axis. The second rotational direction is opposite the first rotational direction around the vertical axis. For example, when the first rotational direction is a clockwise direction around the vertical axis, the second rotational direction is a counterclockwise direction around the vertical axis. Rotating the mechanical auger 309 in the second rotational direction pushes the ink in the ink reservoir 302 outward from the nozzle 303 into the ink fountain 47. Once a sufficient volume of ink is pushed into the ink fountain 47, the robotic arm 60 returns the ink refill cartridge 300 to a desired location and uncouples from the ink refill cartridge 300. As such, the robotic arm 60 may couple with another ink refill cartridge corresponding to a different ink station assembly 46 in need of refill.

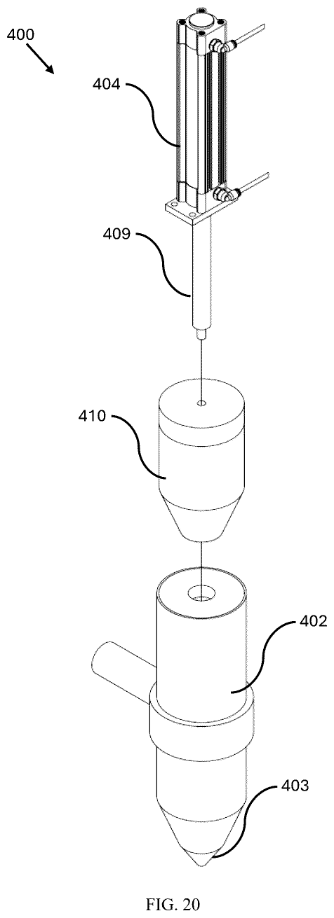

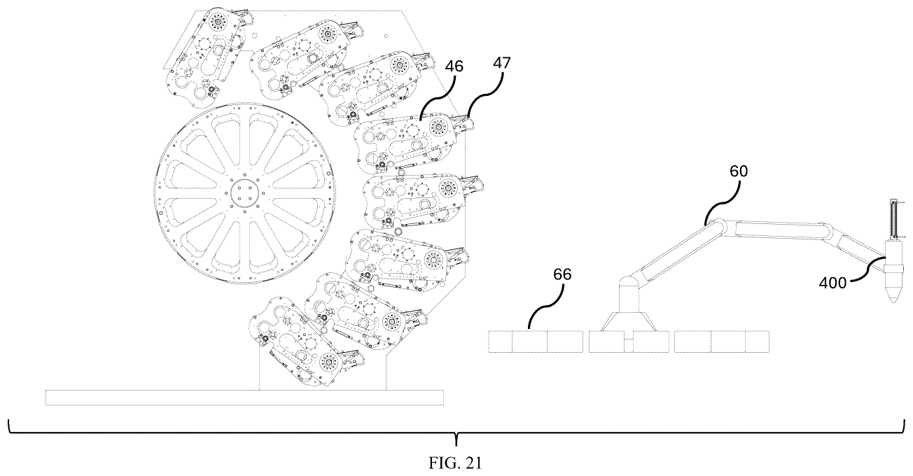

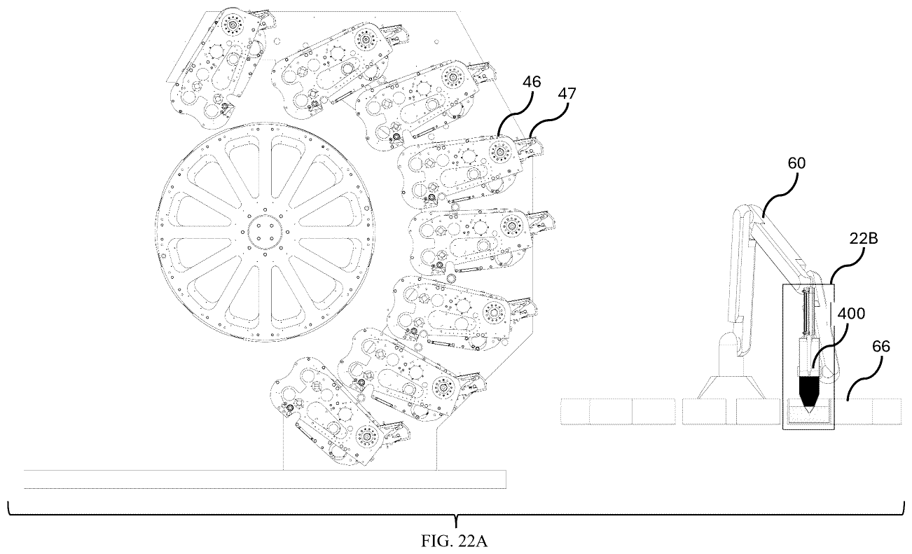

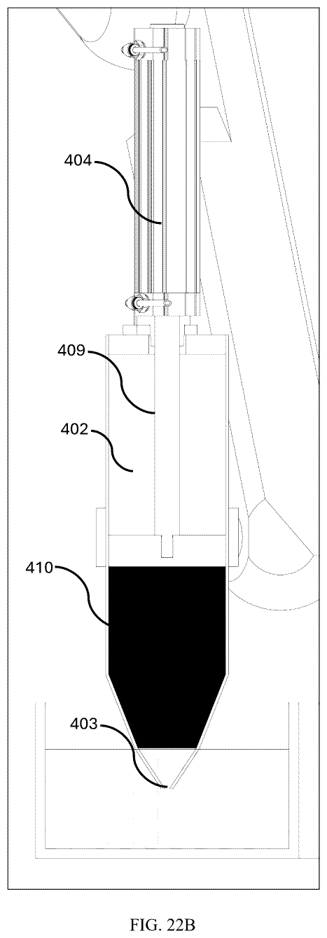

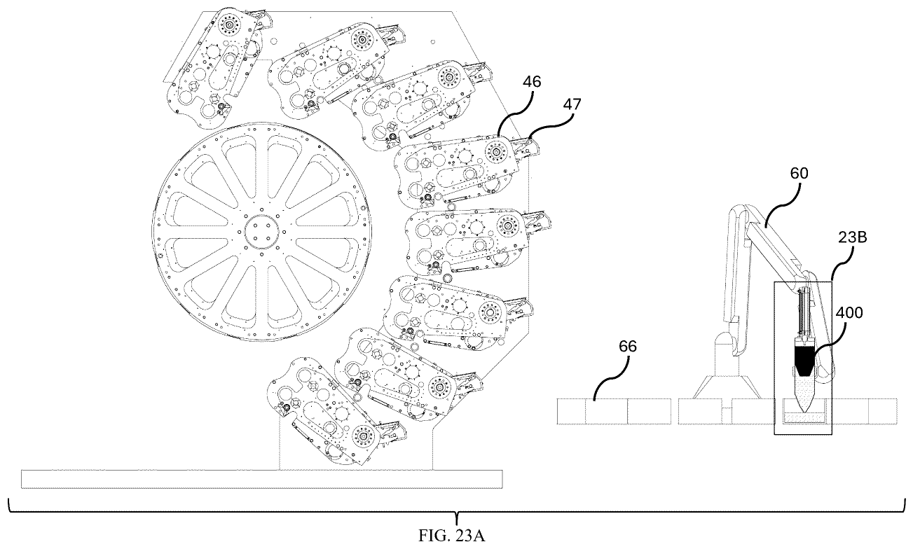

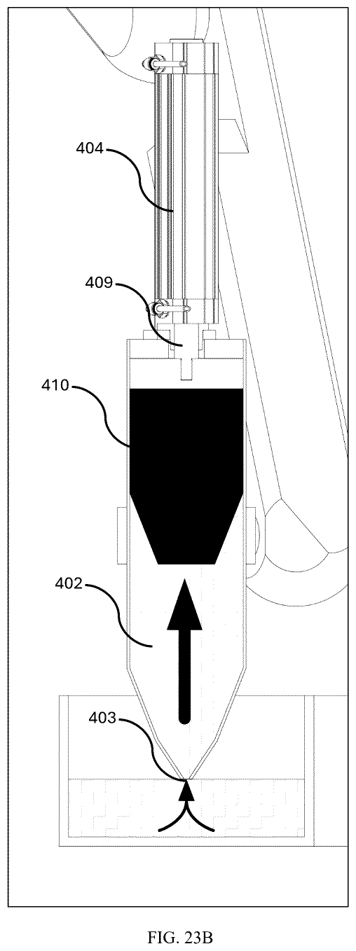

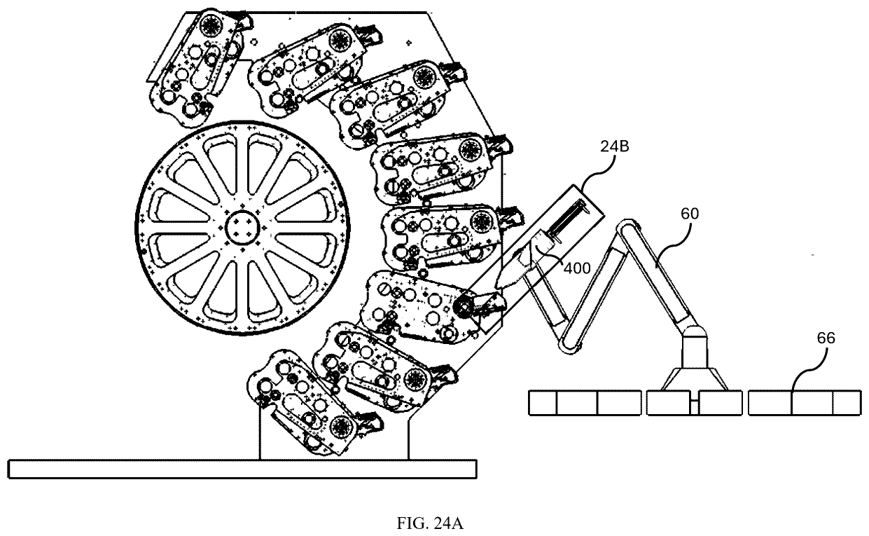

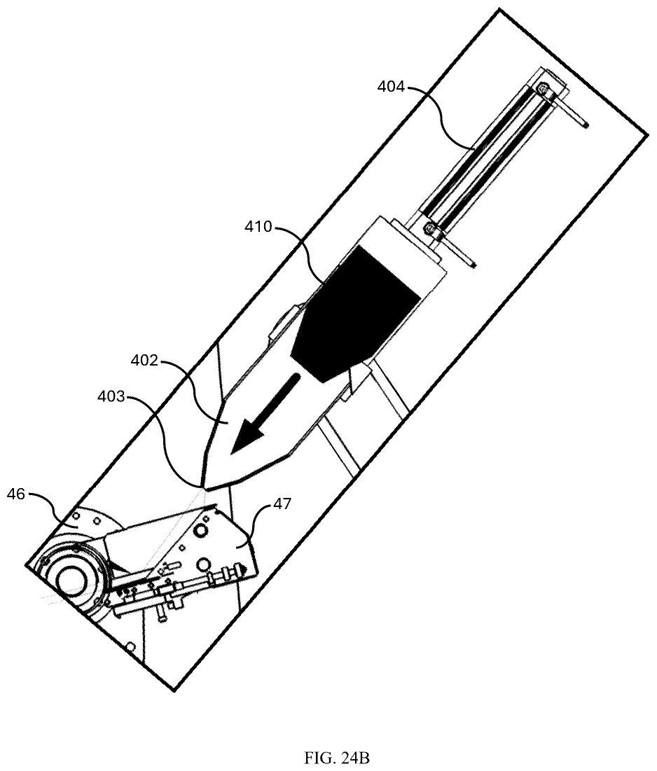

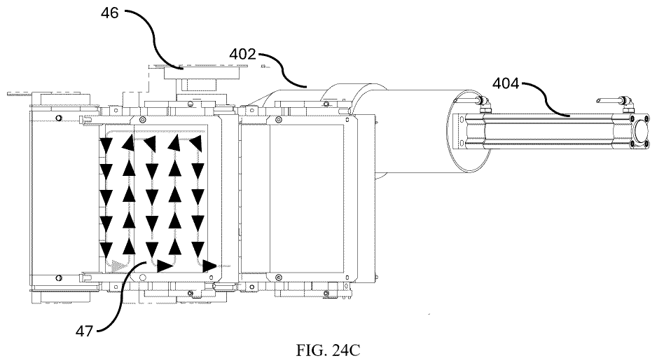

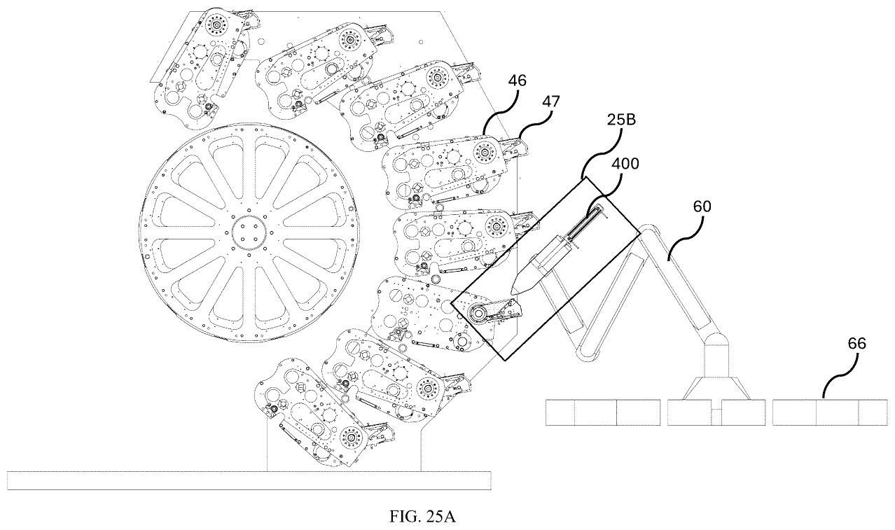

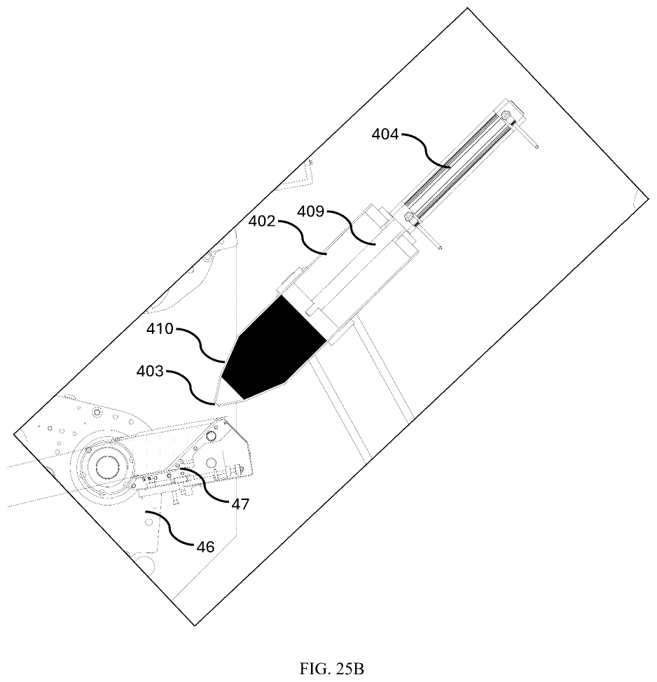

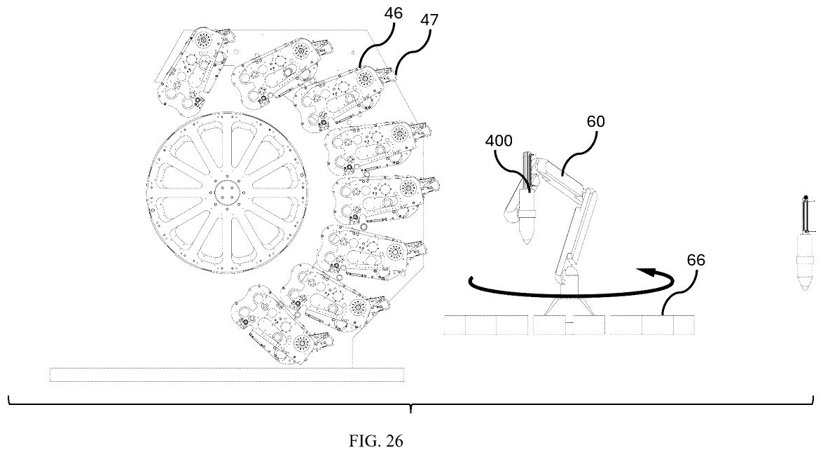

In the optional embodiment shown in FIGS. 20-26, the actuator is a pneumatic cylinder 404. The pneumatic cylinder 404 may include an air cylinder 409 operably connected to a plunger 410. In FIGS. 22A and 22B, the plunger 410 is in an extended position, putting the plunger 410 near the nozzle 403 of the ink refill cartridge 400. The pneumatic cylinder 404 is ideal for use with inks of lower viscosities. As demonstrated in FIGS. 23A and 23B, the input direction of the actuator is defined where the air cylinder 409 pulls the plunger 410 away from the nozzle 403 of the ink refill cartridge 400. This creates a vacuum that pulls the fluid, such as ink, into the ink reservoir 402 through the nozzle 403. Actuating the air cylinder 409 and plunger 410 in the input direction may allow for the ink reservoir 402 to be entirely filled with the fluid, such as ink. As demonstrated in FIGS. 24A, 24B and 24C, the actuator is moved into the output direction, where the air cylinder 409 pushes the plunger 410 towards the nozzle 403. This creates pressure that pushes the fluid, such as ink, out from the ink reservoir 402 out through the nozzle 403. As shown in FIGS. 25A and 25B, the ink reservoir 402 may be depleted through the movement of the air cylinder 409 and plunger 410 in the output direction. In an optional embodiment, the plunger 410 is shaped to fully evacuate the fluid, such as ink, from the ink reservoir 402.

In use, the ink refill cartridge 400 of the optional embodiment of FIGS. 20-26 is coupled to the robotic arm 60. The robotic arm 60 is configured to place the ink refill cartridge 400 into a corresponding ink pail 66. Once the nozzle 403 is at least partially submerged in the ink stored in the ink pail 66, the air cylinder 409 is moved in the input direction. When moved in the input direction, the air cylinder 409 pulls the plunger 410 upward, creating a vacuum that pulls the ink in the ink pail 66 through the nozzle 403 and into the ink reservoir 402. Once the ink reservoir 402 is sufficiently filled with ink, the robotic arm 60 moves the ink refill cartridge 400 to an ink fountain 47 of a corresponding ink station assembly 46. When the nozzle 403 is aligned with the ink fountain 47, the air cylinder 409 is moved in the output direction. When the air cylinder 409 is moved in the output direction, the plunger 410 is moved toward the nozzle 403, pushing the ink in the ink reservoir 402 out from the nozzle 403 and into the ink fountain 47. Once a sufficient volume of ink is pushed into the ink fountain 47, the robotic arm 60 returns the ink refill cartridge 400 to a desired location and uncouples from the ink refill cartridge 400. As such, the robotic arm 60 may couple with another ink refill cartridge corresponding to a different ink station assembly 46 in need of refill.

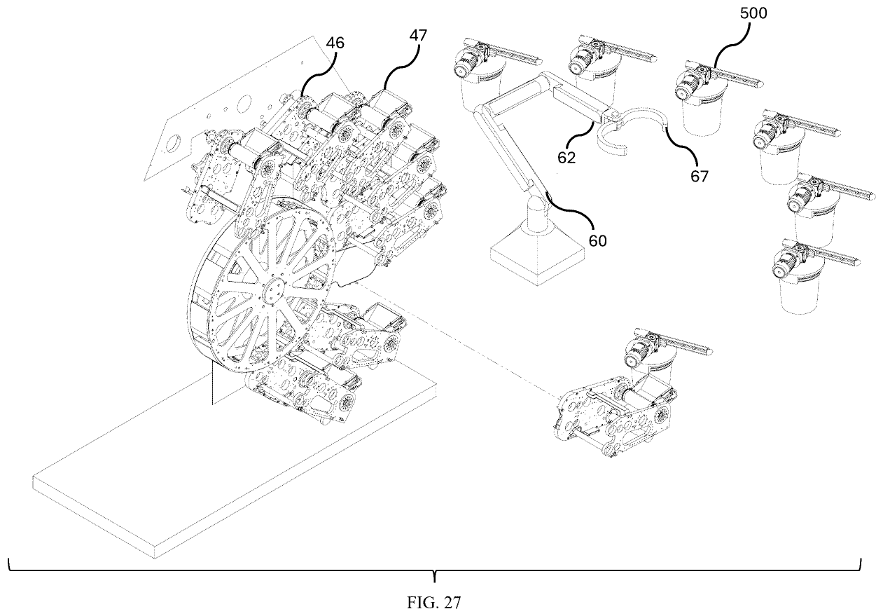

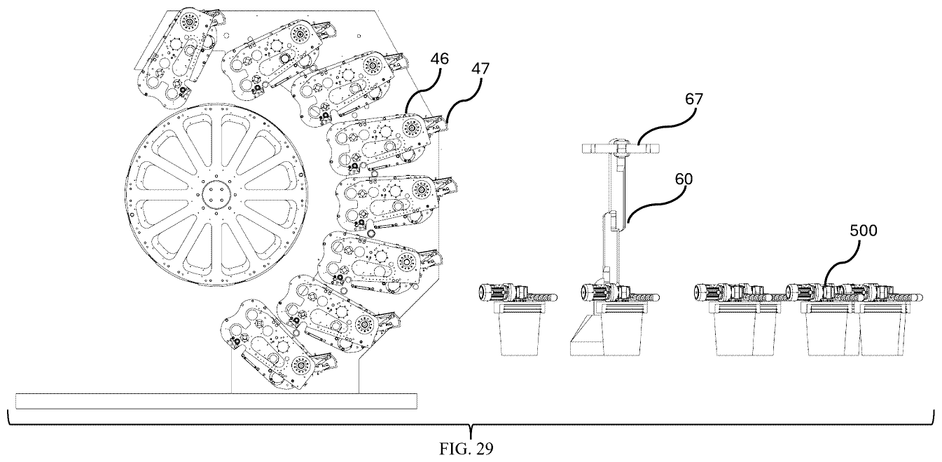

In the optional embodiment shown in FIGS. 27-33, the ink refill cartridge 500 may be configured to secure to an opening of the ink pail 566. Specifically, in the demonstrated embodiment, the ink refill cartridge 500 includes an ink pail support frame or lid 501. The ink pail support frame 501 is configured to be removably secured the ink pail 566 to the ink refill cartridge 500. For example, the ink pail support frame 501 may removably secure to the ink pail 566 via a threaded connection. Alternatively, the ink pail support frame 501 may be secured to the ink pail 566 through a different attachment mechanism, such as a snap-fit connection or a friction-fit connection or a fastener. The ink pail support frame 501 may include an ink pail auger 509A disposed on an inner surface thereof, and an ink pail support frame opening 511 disposed or extending therethrough. Optionally, the ink pail support frame opening 511 may be crescent or kidney-shaped, and be positioned only on one half of the opening 511 when the ink pail support frame 501 is viewed from above.

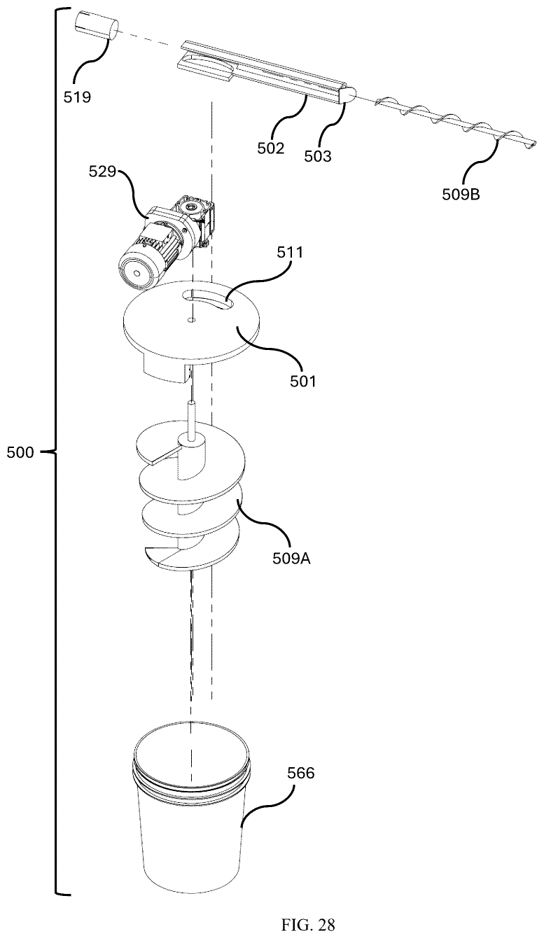

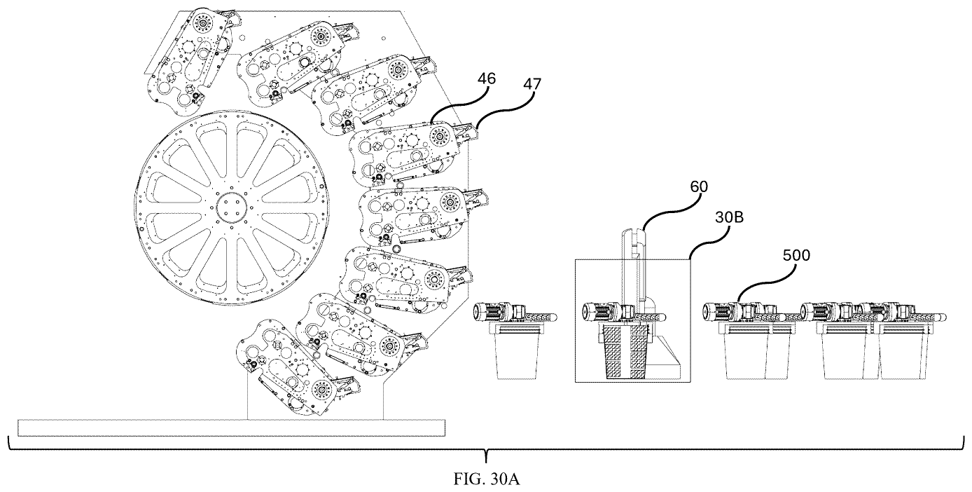

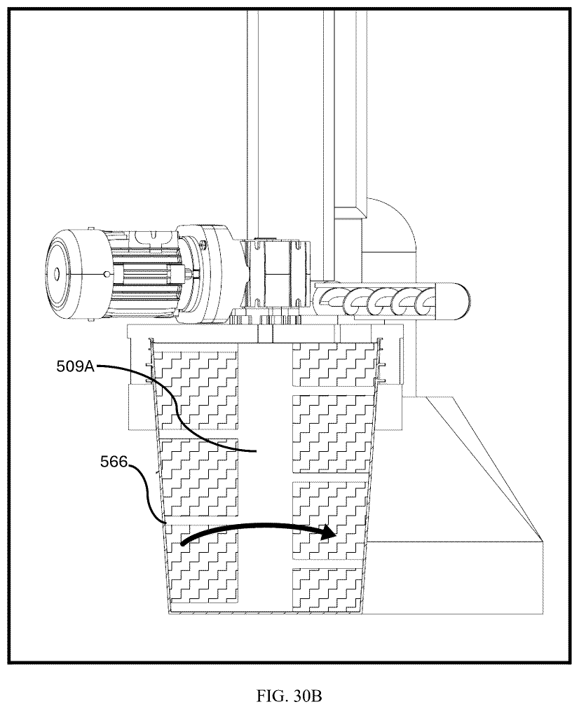

As shown in FIGS. 30A and 30B, the ink pail auger 509A is configured to feed or move ink from the ink pail 566 through the ink pail support frame opening 511 into the ink reservoir. In the illustrated embodiment, the ink reservoir is an ink or dispenser trough 502 disposed on, near, or adjacent to an outer surface of the ink pail support frame 501. The ink pail auger 509A may be operatively connected to an ink pail motor or actuator 529 (see FIG. 28), such that rotational force may be applied to the ink pail auger 509A by the ink pail motor 529 to rotate the ink pail auger 509A.

Furthermore, in the illustrated embodiment, the dispenser trough 502 includes a dispenser auger 509B. A longitudinal axis of the dispenser auger 509B may extend perpendicularly to a longitudinal axis of the ink pail auger 509A. The dispenser auger 509B is in operable connection with the dispenser trough 502, such that ink may be released from the dispenser trough 502 through actuation of the dispenser auger 509B. The dispenser auger 509B may be in operable connection with a dispenser motor 519, wherein the dispenser motor 519 is configured to rotate the dispenser auger 509B when actuated. The dispenser trough 502 may include a nozzle 503 through which ink may be pushed when the dispenser auger 509B is rotated. Optionally, the nozzle 503 may include a cover 531, such as to prevent dripping of ink out of the ink trough 502. The cover 531 may be secured to the ink trough by a hinge.

In use, the ink refill cartridge 500 of the optional embodiments of FIGS. 27-33 are coupled to the robotic arm 60. The ink refill cartridge 500 and its ink pail 566 of the optional embodiment of FIGS. 27-33 may be collectively secured by the robotic arm 60. As shown in the exemplary optional embodiment shown in FIG. 27, the robotic arm 60 may include a clamp 67 or other attachment mechanism disposed on the distal end 62 of the robotic arm 60. The clamp 67 defines a circular area in which the robotic arm 60 may secure a circular container, such as an ink pail 566. Once secured to the robotic arm 60, the ink refill cartridge 500 may be positioned near the ink station assembly 46.

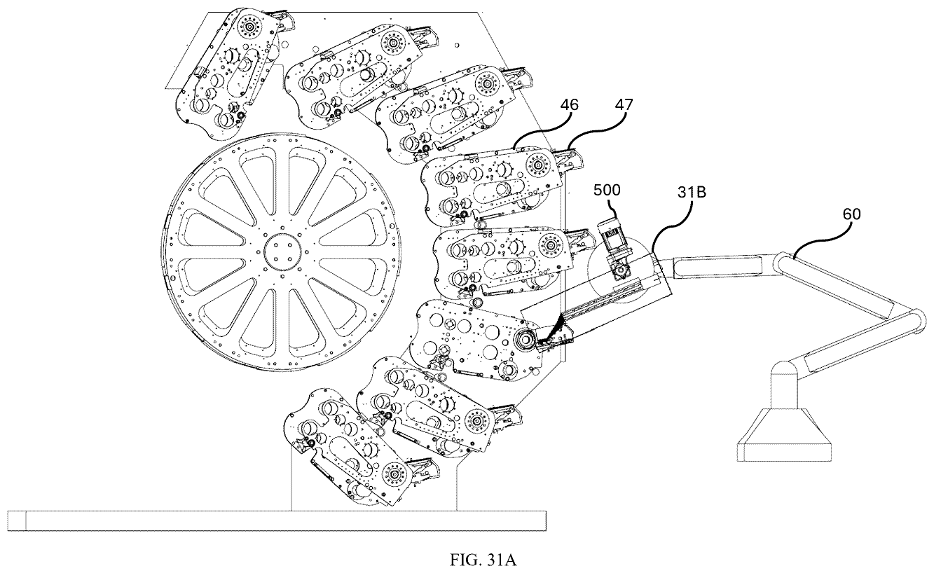

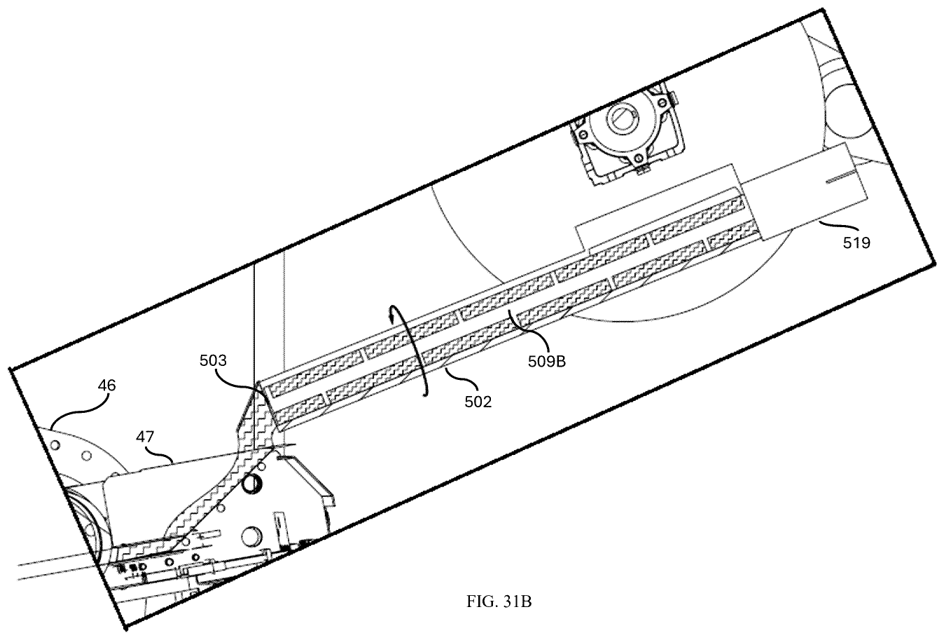

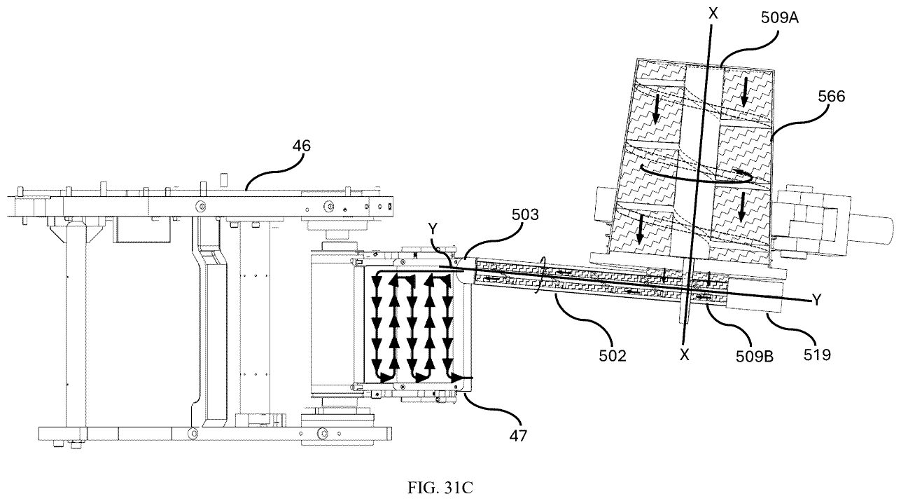

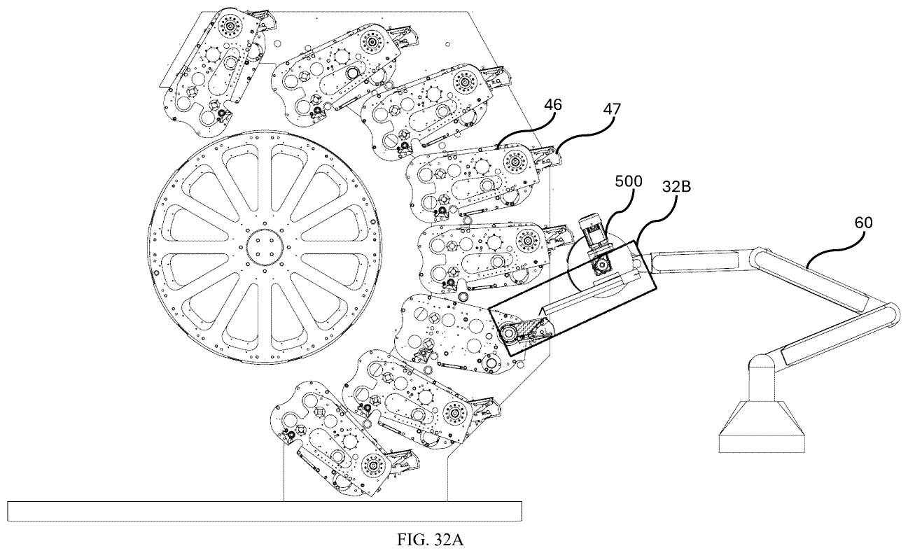

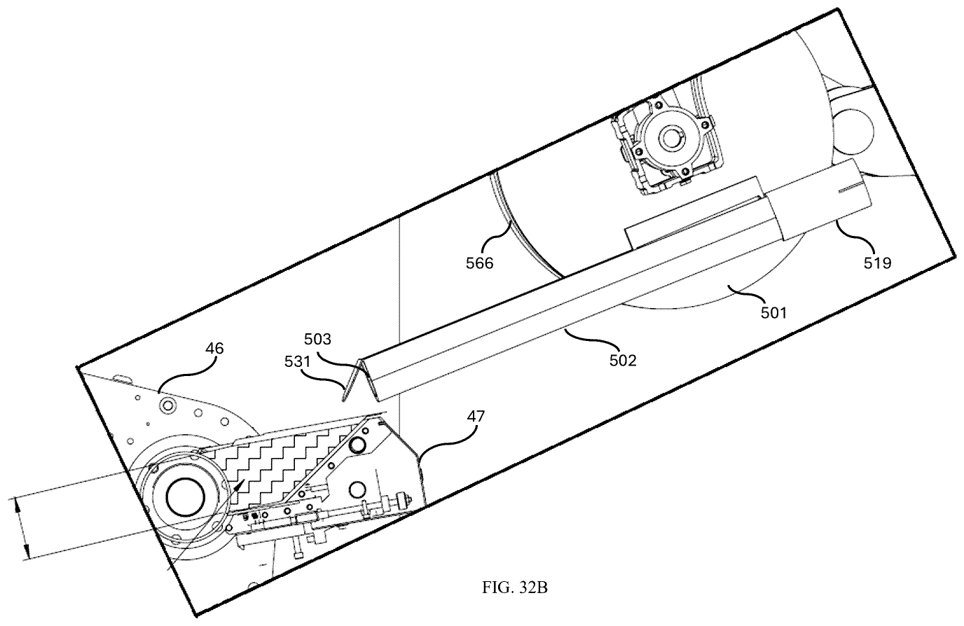

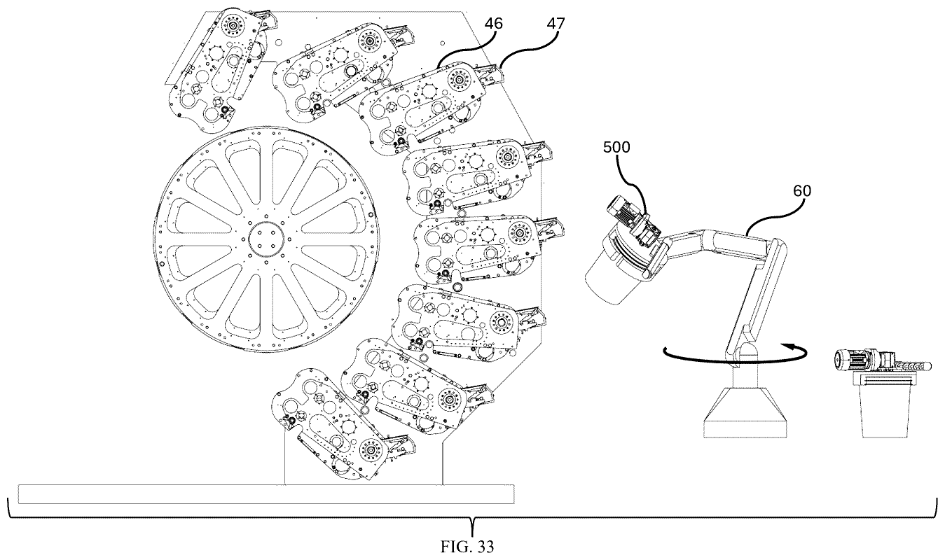

As shown in FIGS. 30A and 30B, the ink pail auger 509A may rotate in a first rotational direction around a vertical axis X-X defined by the ink pail auger 509A. When the ink pail auger 509A rotates in the first rotational direction (e.g., counterclockwise when viewed from above), ink may be moved from the ink pail 566 towards the ink pail support frame opening 511. When ink passes through the ink pail support frame opening 511, it may flow into the dispenser trough 502. The dispenser auger 509B may be rotated in a first rotational direction around a horizontal axis Y-Y defined by the dispenser auger 509B. As shown in FIGS. 31A and 31B, the dispenser auger 509B is rotated in the first rotational direction, ink may be moved from the dispenser trough 502 toward the nozzle 503. Ultimately, the ink will be dispensed into the ink fountain 47 of the ink station assembly 46 of the can decorator. Once a sufficient volume of ink is pushed into the ink fountain 47, as shown in FIGS. 32A and 32B, the robotic arm 60 returns the ink refill cartridge 500 to a desired location and uncouples from the ink refill cartridge 500, as shown in FIG. 33. As such, the robotic arm 60 may couple with another ink refill cartridge 500 corresponding to a different ink station assembly 46 in need of refill.

As shown in FIGS. 17C, 24C, and 31C, the robotic arm 60 may be configured to move the ink dispenser cartridge 500 in a sweeping pattern as it is dispensing ink from the nozzle 503, such that ink will be evenly distributed into the ink fountain 47 of the ink station assembly 46. In an exemplary embodiment, the sweeping pattern is defined where the nozzle 503 is moved along a first lateral side of the ink fountain from a distal end of the ink fountain 47 towards the ink station assembly 46, then towards an opposing second lateral side of the ink fountain 47. In the exemplary embodiment, the nozzle 503 is moved back and forth between the first lateral side and the opposing lateral side from a proximal end of the ink fountain 47 towards the distal end of the ink fountain 47. Furthermore, in an exemplary embodiment, the ink refill cartridge 500 is configured to release a measured amount of ink. As such, the robotic arm 60 may be integrated with a feedback system configured to determine a calculated volume of ink which is to be dispersed into an ink fountain. For example, in an exemplary embodiment, each ink fountain 47 may include a scale in operable connection with a processor. The processor may be further operatively connected to the robotic arm 60 and the ink refill cartridge 500, such that the calculated volume of ink is released from the ink refill cartridge 500 into the targeted ink fountain 47.

The following exemplary embodiments further describe optional aspects of the presently disclosed technology and are part of this Detailed Description. These exemplary embodiments are set forth in a format substantially akin to claims, although they are not technically claims of the present application. The following exemplary embodiments refer to each other in dependent relationships as “embodiments” instead of “claims”.

1A. An ink refill cartridge for a decorator machine for a can product line, the ink refill cartridge comprising:
a body having an ink reservoir with a nozzle disposed on an end thereof, the nozzle being in fluid communication with the ink reservoir;
an actuator disposed in the ink reservoir, the actuator being movable between a first direction and a second direction, the actuator being configured to move a fluid into the ink reservoir through the nozzle when operated in a first direction, the actuator being configured to move the fluid from the ink reservoir out through the nozzle when operated in a second direction; and
a coupling assembly configured to attach the ink refill cartridge to a robotic arm.

2A. The ink refill cartridge of embodiment of 1A, wherein the actuator is a pneumatic cylinder comprising an air cylinder operably connected to a plunger.

3A. The ink refill cartridge of embodiment 2A, wherein the first direction is defined where the air cylinder is pulled away from the nozzle, thereby creating a vacuum to pull the fluid into the ink reservoir through the nozzle.

4A. The ink refill cartridge of embodiment 2A, wherein the second direction is defined where the cylinder is pushed towards the nozzle, thereby creating pressure to push the fluid out through the nozzle.

5A. The ink refill cartridge of embodiment 1A, wherein the actuator is operably connected to a screw jack.

6A. The ink refill cartridge of embodiment 5A, wherein the first direction is defined where the screw jack is rotated along a vertical axis in a first rotational direction, moving the plunger away from the nozzle, thereby creating a vacuum to pull the fluid into the ink reservoir through the nozzle.

7A. The ink refill cartridge of embodiment 5A, wherein the second direction is defined where the screw jack is rotated along a vertical axis in a second rotational direction, moving the plunger toward the nozzle, thereby creating pressure to push the fluid through the nozzle.

8A. The ink refill cartridge of embodiment 1A, wherein the actuator is a mechanical auger.

9A. The ink refill cartridge of embodiment 8A, wherein the first direction is defined where the mechanical auger is rotated along a vertical axis in a first rotational direction, thereby pulling the fluid into the ink reservoir through the nozzle.

10A. The ink refill cartridge of embodiment 8A, wherein the second direction is defined where the mechanical auger is rotated along a vertical axis in a second rotational direction, thereby pushing the fluid from the ink reservoir through the nozzle and out of the ink refill cartridge.

1B. An apparatus for refilling a plurality of ink fountains on a can decorator, the apparatus comprising:
a plurality of ink pails;
   a plurality of ink refill cartridges, each ink refill cartridge comprising a body having an ink reservoir and a coupling assembly configured to attach the ink refill cartridge to a robotic arm, the ink reservoir having a nozzle disposed on an end thereof, the nozzle being in fluid communication with the ink reservoir, an actuator disposed in the ink reservoir being configured to move a fluid into the ink reservoir from the nozzle when operated in a first direction, the actuator being configured to move the fluid from the ink reservoir out through the nozzle when operated in a second direction, each ink refill cartridge corresponding to an ink pail of the plurality of ink pails; and
   a robotic arm comprising a proximal end connected to a base and a distal end configured to attach to the coupling assembly of an ink refill cartridge of the plurality of refill cartridges.

2B. The apparatus of embodiment 1B, wherein the actuator is a pneumatic cylinder comprising an air cylinder in operable connection with a plunger.

3B. The apparatus of embodiment 2B, wherein the first direction is defined where the air cylinder is pulled away from the nozzle, thereby creating a vacuum to pull the fluid through the nozzle.

4B. The apparatus of embodiment 2B, wherein the second direction is defined where the cylinder is pushed towards the nozzle, thereby creating pressure to push the fluid through the nozzle.

5B. The apparatus of embodiment 1B, wherein the actuator is a plunger in operable connection with a screw jack.

6B. The apparatus of embodiment 5B, wherein the first direction is defined where the screw jack is rotated along a vertical axis in a first rotational direction, moving the plunger away from the nozzle, thereby creating a vacuum to pull the fluid into the ink reservoir through the nozzle.

7B. The apparatus of embodiment 5B, wherein the second direction is defined where the screw jack is rotated along a vertical axis in a second rotational direction, moving the plunger toward the nozzle, thereby creating pressure to push the fluid through the nozzle.

8B. The apparatus of embodiment 1B, wherein the actuator is a mechanical auger.

9B. The apparatus of embodiment 8B, wherein the first direction is defined where the mechanical auger is rotated along a vertical axis in a first rotational direction, thereby pulling the fluid into the ink reservoir through the nozzle.

10B. The apparatus of embodiment 8B, wherein the second direction is defined where the mechanical auger is rotated along a vertical axis in a second rotational direction, thereby pushing the fluid from the ink reservoir through the nozzle and out of the ink refill cartridge.

1C. An ink refill cartridge for a decorator machine for a can product line, the ink refill cartridge comprising:
a dispenser trough comprising a nozzle at one end thereof;
a dispenser motor operatively connected to a dispenser actuator disposed at least partially within the ink trough, the dispensing motor being configured to rotate the dispenser actuator within the ink trough;
an ink pail support frame in fluid communication with the ink trough, the ink pail support frame being removably attachable to an ink pail configured to hold ink; and
an ink pail actuator being positioned at least partially in the ink pail, the ink pail actuator being operatively connected to an ink pail motor,
wherein the ink pail actuator is configured to move ink from the ink well to the dispenser trough.

2C. The ink refill cartridge of embodiment 1C, wherein the dispenser actuator is a dispenser auger.

3C. The ink refill cartridge of embodiment 1C, wherein the ink pail actuator is an ink pail auger.

4C. The ink refill cartridge of embodiment 1C, wherein a longitudinal axis of the dispenser actuator extends perpendicularly to a longitudinal axis of the ink pail actuator.

5C. The ink refill cartridge of embodiment 1C, wherein rotation of the dispenser actuator by the dispenser motor moves ink out of the ink trough through the nozzle.

6C. The ink refill cartridge of embodiment 1C, wherein rotation of the ink pail actuator by the ink pail motor moves ink upwardly from the ink pail, through an opening in the ink pail support frame and into the ink trough.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. An ink refill cartridge for a decorator machine for a can production line, the ink refill cartridge comprising:
a body having an ink reservoir with a nozzle disposed on an end thereof, the nozzle being in fluid communication with the ink reservoir; and
an actuator disposed in the ink reservoir, the actuator being movable in an output direction, the actuator being configured to move the fluid from the ink reservoir out through the nozzle when operated in the output direction.

2. The ink refill cartridge of claim 1, wherein the actuator is a pneumatic cylinder comprising an air cylinder operably connected to a plunger.

3. The ink refill cartridge of claim 2, wherein the actuator is configured to move a fluid into the ink reservoir through the nozzle when operated in an input direction, wherein the input direction is defined where the air cylinder is pulled away from the nozzle, thereby creating a vacuum to pull the fluid into the ink reservoir through the nozzle.

4. The ink refill cartridge of claim 2, wherein the output direction is defined where the cylinder is pushed towards the nozzle, thereby creating pressure to push the fluid out through the nozzle.

5. The ink refill cartridge of claim 1, wherein the actuator is a plunger operably connected to a screw jack.

6. The ink refill cartridge of claim 5, wherein the actuator is configured to move a fluid into the ink reservoir through the nozzle when operated in an input direction, wherein the input direction is defined where the screw jack is rotated along a vertical axis in a first rotational direction, moving the plunger away from the nozzle, thereby creating a vacuum to pull the fluid into the ink reservoir through the nozzle.

7. The ink refill cartridge of claim 5, wherein the output direction is defined where the screw jack is rotated along a vertical axis in a second rotational direction, moving the plunger toward the nozzle, thereby creating pressure to push the fluid through the nozzle.

8. The ink refill cartridge of claim 1, wherein the actuator is a mechanical auger.

9. The ink refill cartridge of claim 8, wherein the mechanical actuator is configured to move a fluid into the ink reservoir through the nozzle when operated in an input direction, wherein the input direction is defined where the mechanical auger is rotated along a vertical axis in a first rotational direction, thereby pulling the fluid into the ink reservoir through the nozzle.

10. The ink refill cartridge of claim 8, wherein the output direction is defined where the mechanical auger is rotated along a vertical axis in a second rotational direction, thereby pushing the fluid from the ink reservoir through the nozzle and out of the ink refill cartridge.

11. The ink refill cartridge of claim 1, wherein the ink refill cartridge is configured secure to an opening of an ink pail, such that the ink pail is in fluid communication with the ink reservoir.

12. The ink refill cartridge of claim 11, wherein an ink pail actuator is disposed in the ink pail, the ink pail actuator configured to drive ink out of the ink pail into the ink reservoir.

13. The ink refill cartridge of claim 12, wherein the ink pail actuator is an ink pail auger.

14. The ink refill cartridge of claim 1, wherein the ink reservoir is a dispenser trough.

15. The ink refill cartridge of claim 1, further comprising a coupling assembly configured to attach the ink refill cartridge to a robotic arm.

16. An apparatus for refilling a plurality of ink fountains on a can decorator, the apparatus comprising:
a plurality of ink refill cartridges, each ink refill cartridge comprising a body having an ink reservoir and a coupling assembly configured to attach the ink refill cartridge to a robotic arm, the ink reservoir having a nozzle disposed on an end thereof, the nozzle being in fluid communication with the ink reservoir, an actuator disposed in the ink reservoir being configured to move the fluid from the ink reservoir out through the nozzle when operated in an output direction; and
a robotic arm comprising a proximal end connected to a base and a distal end configured to hold an ink refill cartridge of the plurality of refill cartridges.

17. The apparatus of claim 16, wherein the actuator is a pneumatic cylinder comprising an air cylinder in operable connection with a plunger.

18. The apparatus of claim 16, wherein the actuator is configured to move a fluid into the ink reservoir through the nozzle when operated in an input direction, wherein the input direction is defined where the air cylinder is pulled away from the nozzle, thereby creating a vacuum to pull the fluid into the ink reservoir through the nozzle.

19. The apparatus of claim 16, wherein the output direction is defined where the cylinder is pushed towards the nozzle, thereby creating pressure to push the fluid through the nozzle.

20. The apparatus of claim 16, wherein the actuator is a plunger in operable connection with a screw jack.

21. The apparatus of claim 20, wherein the actuator is configured to move a fluid into the ink reservoir through the nozzle when operated in an input direction, wherein the input direction is defined where the screw jack is rotated along a vertical axis in a first rotational direction, moving the plunger away from the nozzle, thereby creating a vacuum to pull the fluid into the ink reservoir through the nozzle.

22. The apparatus of claim 20, wherein the output direction is defined where the screw jack is rotated along a vertical axis in a second rotational direction, moving the plunger toward the nozzle, thereby creating pressure to push the fluid through the nozzle.

23. The apparatus of claim 16, wherein the actuator is a mechanical auger.

24. The apparatus of claim 23, wherein the mechanical actuator is configured to move a fluid into the ink reservoir through the nozzle when operated in an input direction, wherein the input direction is defined where the mechanical auger is rotated along a vertical axis in a first rotational direction, thereby pulling the fluid into the ink reservoir through the nozzle.

25. The apparatus of claim 23, wherein the output direction is defined where the mechanical auger is rotated along a vertical axis in a second rotational direction, thereby pushing the fluid from the ink reservoir through the nozzle and out of the ink refill cartridge.

26. The apparatus of claim 16, wherein the ink refill cartridge is configured secure to an opening of an ink pail, such that the ink pail is in fluid communication with the ink reservoir.

27. The apparatus of claim 16, wherein the ink refill cartridge is configured secure to an opening of an ink pail, such that the ink pail is in fluid communication with the ink reservoir.

28. The apparatus of claim 26, wherein an ink pail actuator is disposed in the ink pail, such as to drive ink out of the ink pail into the ink reservoir.

29. The apparatus of claim 28, wherein the ink pail actuator is an ink pail auger.

30. The apparatus of claim 16, wherein the ink reservoir is a dispenser trough.

31. A method of transferring ink to an ink fountain of a decorator machine for a can production line, the method comprising:
identifying a target ink fountain to be filled;
identifying the ink refill cartridge corresponding to the target ink fountain;
attaching a distal end of a robotic arm to a coupling assembly of the ink refill cartridge;
moving the nozzle of the ink refill cartridge into the target ink fountain; and
actuating the actuator of the ink refill cartridge in an output direction to release ink into the ink fountain.

32. The method of claim 31, further comprising:
identifying an ink pail corresponding to the ink fountain to be filled;
moving the nozzle of the ink refill cartridge into the ink fountain;
actuating an actuator of an ink refill cartridge in an output direction.

33. The method of claim 31, further comprising:
placing the nozzle of the ink refill cartridge into an ink pail;
actuating the actuator of the ink refill cartridge in an input direction to fill the reservoir of the ink refill cartridge with the fluid.

34. The method of claim 31, further comprising:
securing the ink pail to an ink reservoir of the ink refill cartridge.

35. The method of claim 31, further comprising:
removing the ink refill cartridge from the distal end of the robotic arm by disengaging the coupling assembly.

36. The method of claim 31, further comprising:
moving the nozzle of the ink refill cartridge in a sweeping pattern while filling the target ink fountain.

37. The method of claim 31, further comprising:
calculating a volume of ink to be released into the target ink fountain.
